(19) United States
(12) Patent Application Publication
(10) Pub. No.: US 2011/0152428 A1
(43) Pub. Date: Jun. 23, 2011

(54) HIGH-MOLECULAR DISPERSANT FOR INORGANIC PIGMENTS

(75) Inventors: Shuichi Inaya, Wakayama-shi (JP); Kazuo Kuwahara, Wakayama-shi (JP); Takahiro Oshima, Wakayama-shi (JP)

(73) Assignee: KAO CORPORATION, Tokyo (JP)

(21) Appl. No.: 13/060,800

(22) PCT Filed: Aug. 21, 2009
(86) PCT No.: PCT/JP2009/064609

§ 371 Date: Feb. 25, 2011

(30) Foreign Application Priority Data
Aug. 27, 2008 (JP) 2008-217602
Mar. 19, 2009 (JP) 2009-068058

(51) Int. Cl. C08F 20/06; C08F 30/04; C08L 33/10; C08K 3/26; C08K 3/22

(52) U.S. Cl. 524/413; 526/318.5; 526/240; 524/558; 524/424; 524/433

(57) ABSTRACT

A high-molecular dispersant suitable for basic inorganic pigments in non-aqueous systems is provided. The high-molecular dispersant contains a copolymer that contains a constitutional unit (a), a constitutional unit (b), and a constitutional unit (c), wherein the constitutional unit (a) accounts for 5 to 45 wt % of the total amount of the constitutional units, the constitutional unit (b) accounts for 50 to 90 wt % of the total amount of the constitutional units, and a ratio by weight of the constitutional unit (c) with respect to the constitutional unit (b) (constitutional unit (c)/constitutional unit (b)) is 0.05 to 0.7, wherein the constitutional unit (a) is a constitutional unit represented by a general formula (1), the constitutional unit (b) is either a constitutional unit represented by a general formula (2-1), or a constitutional unit originating from a macromonomer having an ethylenically unsaturated double bond at one of the terminals of a polymer main chain of the macromonomer, the polymer main chain having a repetitive unit represented by a general formula (2-2), and the constitutional unit (c) is a constitutional unit represented by a general formula (3).

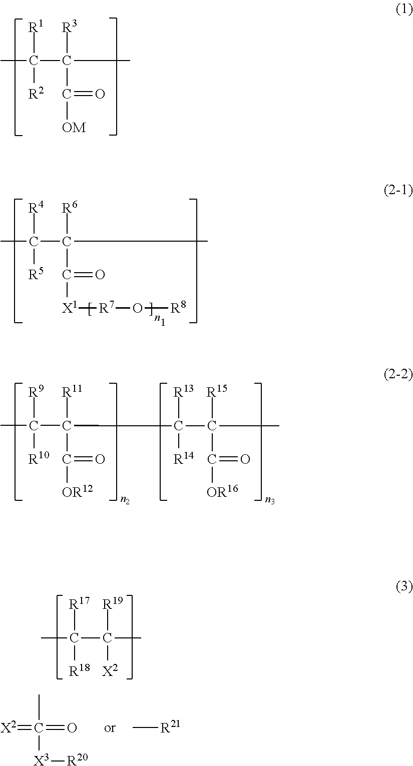

### TECHNICAL FIELD

The present invention relates to a high-molecular dispersant for inorganic pigments, a dispersing method using the same, and a slurry composition using the same.

### BACKGROUND ART

The Patent Document 1 refers to polycarboxylic acid-type dispersants and polymaleic acid-type dispersants as dispersants used in basic inorganic pigments. The aforementioned document however does not disclose any specific structure thereof. On the other hand, the following are disclosed as binders for ceramics formation in a non-aqueous system: a copolymer formed of a (meth)acrylic acid ester and a (meth)acrylic acid ester having a polyoxyethylene chain at a specific ratio (Patent Document 2); and a copolymer for a ceramics-forming slurry composition, the copolymer being formed of a polyoxyalkylene derivative and a maleic acid (Patent Document 3). Further, the Patent Documents 4 to 6 disclose copolymers having constitutional units originating from macromonomers, as dispersants for pigments in a non-aqueous system.

### PRIOR ART DOCUMENT

### Patent Document

Patent Document 1: JP 2001-114569 A ([0013], Abstract)
Patent Document 2: JP 6 (1994)-72759 A (Claim 1)
Patent Document 3: JP 2007-261911 A (Claim 1, Abstract)
Patent Document 4: JP 2004-18598 A (Claim 1, Abstract)
Patent Document 5: JP 2007-246635 A (Claim 1, Abstract)
Patent Document 6: JP 2007-277506 A (Claim 1, Abstract)

### DISCLOSURE OF INVENTION

### Problem to be Solved by the Invention

In the field of fine ceramics and the like, however, attempts for controlling the nano-scale fine structure so as to achieve downsizing, speeding-up, lower power consumption, higher efficiency, and higher capacity have been made, and a higher-level technique for nano-dispersion of a basic inorganic pigment in a non-aqueous system has been demanded. Therefore, further improvement in performance of a dispersant has been demanded earnestly.

The present invention relates to a high-molecular dispersant for inorganic pigments, a dispersing method using the same, and a slurry composition using the same.

### Means to Solve the Problem

The present invention relates to a high-molecular dispersant for inorganic pigments, the high-molecular dispersant including a copolymer that contains a constitutional unit (a), a constitutional unit (b), and a constitutional unit (c), wherein the constitutional unit (a) accounts for 5 to 45 percent by weight (wt %) of the total amount of the constitutional units, the constitutional unit (b) accounts for 50 to 90 wt % of the total amount of the constitutional units, and a ratio by weight of the constitutional unit (c) with respect to the constitutional unit (b) (constitutional unit (c)/constitutional unit (b)) is 0.05 to 0.7, wherein the constitutional unit (a) is a constitutional unit represented by a general formula (1), the constitutional unit (b) is either a constitutional unit represented by a general formula (2-1), or a constitutional unit originating from a macromonomer having an ethylenically unsaturated double bond at one of the terminals of a polymer main chain of the macromonomer, the polymer main chain having a repetitive unit represented by a general formula (2-2), and the constitutional unit (c) is a constitutional unit represented by a general formula (3).

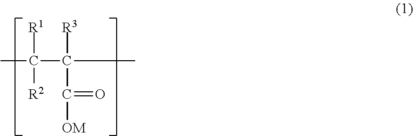

where R¹, R², and R³ are same or different, and each represents a hydrogen atom or an alkyl group having 1 to 2 carbon atoms, and M represents a hydrogen atom or a cation,

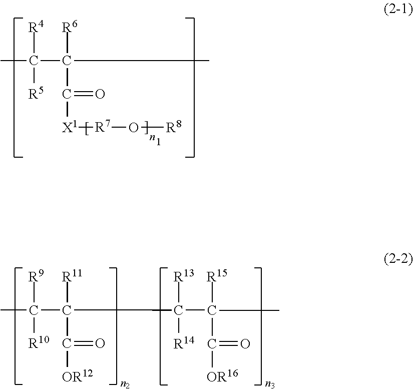

where, in the general formula (2-1), R⁴, R⁵, and R⁶ are same or different, and each represents a hydrogen atom or an alkyl group having 1 to 2 carbon atoms, R⁷ represents a straight-chain or branched-chain alkylene group having 1 to 4 carbon atoms, R⁸ represents a hydrogen atom or an alkyl group having 1 to 2 carbon atoms, X¹ represents an oxygen atom or NH, M represents a hydrogen atom or a cation, and n₁ represents a number in a range of 1 to 50, and

in the general formula (2-2), R⁹, R¹⁰, R¹¹, R¹³, R¹⁴, and R¹⁵ are same or different, and each represents a hydrogen atom or an alkyl group having 1 to 2 carbon atoms, R¹² represents an alkyl group having no alcoholic hydroxyl group and having 1 to 4 carbon atoms, R¹⁶ represents an alkyl group having an alcoholic hydroxyl group and having 1 to 4 carbon atoms, and each of n₂ and n₃ is a positive number representing a molar fraction in the repetitive unit,

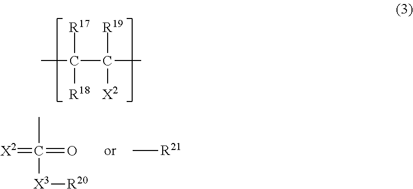

where R¹⁷, R¹⁸, and R¹⁹ are same or different, and each represents a hydrogen atom or an alkyl group having 1 to 2 carbon atoms, X³ represents an oxygen atom or NH, and each of R²⁰ and R²¹ represents an alkyl group, alkenyl group, or aryl group having 1 to 30 carbon atoms.

In another aspect, the present invention is a dispersing method including dispersing a basic inorganic pigment in a non-aqueous solvent with use of the high-molecular dispersant for inorganic pigments of the present invention, wherein a difference (Δsp) between a solubility parameter of the non-aqueous solvent and a solubility parameter of a monomer from which a constitutional unit (c) of the above-described high-molecular dispersant for inorganic pigments originates is 2.0 (MPa)^{1/2} or more.

In still another aspect, the present invention is a slurry composition containing a non-aqueous solvent, a basic inorganic pigment, and the high-molecular dispersant for inorganic pigments of the present invention.

### Effects of the Invention

With the high-molecular dispersant for inorganic pigments of the present invention, for example, an effect of allowing a basic inorganic pigment to be dispersed finely in a non-aqueous solvent is achieved; and preferably, an effect of improving the fine dispersion of a basic inorganic pigment in a non-aqueous solvent is achieved.

### DESCRIPTION OF THE INVENTION

The present invention is based on the finding that excellent fine dispersion of a basic inorganic pigment in a non-aqueous solvent can be achieved (in other words, the basic inorganic pigment can be dispersed in a state in which it has a primary particle diameter, or in a state close to the aforementioned state) by use of a copolymer containing the following constitutional units (a) to (c) that the constitutional units are arranged to be present at a predetermined ratio: a constitutional unit (a) represented by the general formula (1); a constitutional unit (b) which is either a constitutional unit represented by a general formula (2-1), or a constitutional unit originating from a macromonomer having an ethylenically unsaturated double bond at one of the terminals of a polymer main chain of the macromonomer, the polymer main chain having a repetitive unit represented by a general formula (2-2); and a constitutional unit (c) represented by a general formula (3). Details of the mechanism of improvement of fine dispersion of a basic inorganic pigment in a non-aqueous solvent are not clear, but the following can be presumed. First, the constitutional unit (a) in a high-molecular dispersant (copolymer) is strongly adsorbed to mainly a surface of the basic inorganic pigment, whereby the desorption of the high-molecular dispersant from the surface of the basic inorganic pigment is suppressed. Then, the constitutional unit (c) in the high-molecular dispersant suppresses re-elution of the high-molecular dispersant mainly into the non-aqueous solvent, whereby the high-molecular dispersant covers the surfaces of the basic inorganic pigment. Further, the constitutional unit (b) in the high-molecular dispersant as the covering layer (adsorption layer) provides a strong three-dimensional repulsive force mainly between inorganic pigment particles, and consequently suppresses the aggregation of the inorganic pigment particles, whereby the fine dispersion is improved. This however is a presumption, and the present invention is not limited by such mechanisms.

In other words, the present invention in one aspect relates to a high-molecular dispersant for inorganic pigments (hereinafter also referred to as a “high-molecular dispersant of the present invention”), the high-molecular dispersant containing a copolymer that contains a constitutional unit (a), a constitutional unit (b), and a constitutional unit (c), the constitutional unit (a) accounting for 5 to 45 percent by weight (wt %) of the total amount of the constitutional units, the constitutional unit (b) accounting for 50 to 90 wt % of the total amount of the constitutional units, and the ratio by weight of the constitutional unit (c) with respect to the constitutional unit (b) (constitutional unit (c)/constitutional unit (b)) being 0.05 to 0.7, wherein the constitutional unit (a) is a constitutional unit represented by the general formula (1), the constitutional unit (b) is either a constitutional unit represented by the general formula (2-1), or a constitutional unit originating from a macromonomer having an ethylenically unsaturated double bond at one of terminals of polymer main chain of the macromonomer, the polymer main chain having a repetitive unit represented by the general formula (2-2), and the constitutional unit (c) is a constitutional unit represented by the general formula (3). An embodiment of the high-molecular dispersant of the present invention is, for example, a high-molecular dispersant for inorganic pigments that is substantially formed of the above-described copolymer, or a high-molecular dispersant for inorganic pigments that is formed of the above-described copolymer. Another embodiment of the high-molecular dispersant of the present invention is, for example, a high-molecular dispersant for inorganic pigments that contains the above-described copolymer and a solvent (preferably a non-aqueous solvent). With the high-molecular dispersant of the present invention, it is possible to achieve an effect of improvement of preferably, the dispersion of, and more preferably, the fine dispersion of, a basic inorganic pigment in a non-aqueous solvent.

Further, in another aspect, the present invention relates to a dispersing method comprising dispersing a basic inorganic pigment in a non-aqueous solvent with use of the high-molecular dispersant according to the present invention, wherein a difference (Δsp) between a solubility parameter of the non-aqueous solvent and a solubility parameter of a monomer from which a constitutional unit (c) of the high-molecular dispersant originates is 2.0 (MPa)^{1/2} or more. Further, in still another aspect, the present invention relates to a slurry composition containing a non-aqueous solvent, a basic inorganic pigment, and the high-molecular dispersant according to the present invention (hereinafter this slurry composition is also referred to as a “slurry composition of the present invention”).

[Constitutional Unit (a)]

The constitutional unit (a) in the high-molecular dispersant of the present invention is a constitutional unit represented by the general formula (1) shown below. The constitutional unit (a) has a neutralizable acidic group, and is considered as follows: when it strongly adsorbs to surfaces of a basic inorganic pigment, it functions to prevent the high-molecular dispersant (copolymer) from desorbing from surfaces of the basic inorganic pigment.

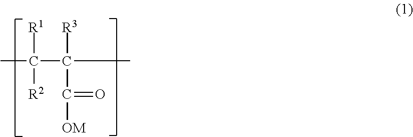

where R¹, R², and R³ may be same or different, and each of the same represents a hydrogen atom or an alkyl group having 1 to 2 carbon atoms, and M represents a hydrogen atom or a cation.

Examples of the constitutional unit (a) include a constitutional unit originating from acidic monomers having a neutralizable acidic group such as a carboxylic group (hereinafter such a monomer is referred to as an “acidic monomer (a)”), and a constitutional unit originating from a monomer to which a neutralizable acidic group can be added after polymerization. Further, the constitutional unit (a) is preferably a constitutional unit originating from a monomer having an ethylenically unsaturated double bond copolymerizable with a nonionic monomer or a macromonomer (both to be described later) that forms the constitutional unit (b). The constitutional unit (a) may be obtained by adding a neutralizable acidic group after polymerization.

Examples of the acidic monomer (a) include a monomer represented by the general formula (4) shown below, and specifically, (meth)acrylic acid, and crotonic acid. However, the acidic monomer (a) is preferably a (meth)acrylic acid, from the viewpoint of improving the fine dispersion of the basic inorganic pigment and facilitating the introduction of the constitutional unit (a) into the high-molecular dispersant.

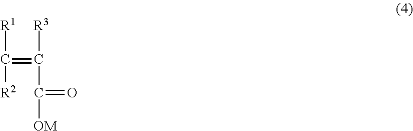

where R¹, R², and R³ may be same or different and each of the same preferably represents a hydrogen atom or an alkyl group having 1 to 2 carbon atoms, and M preferably represents a hydrogen atom or a cation.

In the above general formulae (1) and (4), when M is a cation, the cation is not limited particularly, and examples of the same include a univalent cation; more specifically, examples of the same include univalent metal ion such as Li⁺, Na⁺, and K⁺, ammonium ion, and organic ammonium ion. For the use in electronic materials, ammonium ion and organic ammonium ion are preferred, with consideration to influences of remaining metal ions onto electric characteristics.

In the above-described general formula (4), R¹ and R² are preferably hydrogen atoms, and M is preferably a hydrogen atom, from the viewpoint of improving the fine dispersion of a basic inorganic pigment and facilitating the introduction of the constitutional unit (a) into the high-molecular dispersant.

Further, a method for adding a neutralizable acidic group after polymerization is, for example, a method of converting a non-neutralizable acidic group present in a polymer compound into a neutralizable functional group. In this case, the non-neutralizable acidic group is, for example, an ester group or an amide group. Such a non-neutralizable acidic group may be, for example, hydrolyzed to a neutralizable acidic group such as a carboxyl group.

The percentage of the constitutional unit (a) in the total amount of the constitutional units composing the high-molecular dispersant of the present invention is 5 to 45 wt %, preferably 10 to 40 wt %, and more preferably 10 to 35 wt % with a view to increasing a ratio of adsorption to the basic inorganic pigment so as to improve the fine dispersion of the basic inorganic pigment.

[Constitutional Unit (b)]

The constitutional unit (b) in the high-molecular dispersant of the present invention is either a constitutional unit represented by a general formula (2-1) shown below, or a constitutional unit originating from a macromonomer having an ethylenically unsaturated double bond at one of the terminals of polymer main chain of the macromonomer, the polymer main chain having a repetitive unit represented by a general formula (2-2) shown below. The constitutional unit (b) is nonionic, and is considered to provide a strong three-dimensional repulsive force between basic inorganic pigment particles, thereby consequently suppressing the aggregation of inorganic pigment particles.

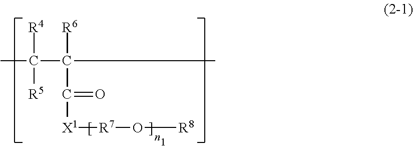

where R⁴, R⁵, and R⁶ may be same or different, and each of the same represents a hydrogen atom or an alkyl group having 1 to 2 carbon atoms, R⁷ represents a straight-chain or branched-chain alkylene group having 1 to 4 carbon atoms, R⁸ represents a hydrogen atom or an alkyl group having 1 to 2 carbon atoms, X¹ represents an oxygen atom or NH, M represents a hydrogen atom or a cation, and n₁ represents a number in a range of 1 to 50.

Examples of the constitutional unit represented by the aforementioned general expression (2-1) (hereinafter this unit is also referred to as a “constitutional unit (b-1)”), among examples of the constitutional unit (b), include a constitutional unit originating from a nonionic monomer (hereinafter also referred to as a “nonionic monomer (b-1)”), and a constitutional unit originating from a monomer to which a nonionic group can be introduced after polymerization. Examples of the nonionic group include polyalkylene groups such as a polyethylene group and a polypropylene group.

Examples of the nonionic monomer (b-1) include methoxy polyethylene glycol (meth)acrylate, methoxy poly(ethylene glycol/propylene glycol) mono(meth)acrylate, ethoxy poly(ethylene glycol/propylene glycol) mono(meth)acrylate, polyethylene glycol mono(meth)acrylate, polypropylene glycol mono(meth)acrylate, 2-methoxyethyl (meth)acrylamide, 2-ethoxyethyl (meth)acrylamide, and 3-methoxypropyl (meth)acrylamide.

Among these, the nonionic monomers represented by the general formula (5) shown below are preferable as the nonionic monomer (b-1), from the viewpoint of improving the fine dispersion of the basic inorganic pigment and the stability of dispersion of the same, and methoxy polyethylene glycol (meth)acrylate in which a polyethylene oxide chain has a polymerization degree of 1 to 50 is more preferable.

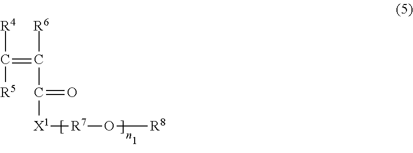

where R⁴, R⁵, and R⁶ may be same or different and each of the same preferably represents a hydrogen atom or an alkyl group having 1 to 2 carbon atoms, R⁷ preferably represents a straight-chain or branched-chain alkylene group having 1 to 4 carbon atoms, R⁸ preferably represents a hydrogen atom or an alkyl group having 1 to 2 carbon atoms, X¹ preferably represents an oxygen atom or NH, and n₁ preferably represents a number in a range of 1 to 50.

In the general formula (5) shown above, from the viewpoint of improving the fine dispersion of the basic inorganic pigment and facilitating the introduction of the constitutional unit (b) into the high-molecular dispersant, R⁴ and R⁵ preferably represent hydrogen atoms, R⁷ preferably represents an ethylene group or a propylene group, and more preferably an ethylene group, and X¹ preferably represents an oxygen atom. Further, in the general formula (5) shown above, from the viewpoint of improving the fine dispersion of the basic inorganic pigment and facilitating the introduction of the constitutional unit (b) into the high-molecular dispersant for the inorganic pigment, n₁ preferably represents a number in a range of 1 to 50, more preferably 1 to 40, and further preferably 1 to 30.

The percentage of the constitutional unit (b-1) in the total amount of the constitutional units composing the high-molecular dispersant of the present invention is 50 to 90 wt %, preferably 55 to 85 wt %, and more preferably 55 to 80 wt %, from the viewpoint of increasing the fine dispersion of the basic inorganic pigment.

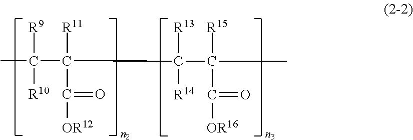

where R⁹, R¹⁰, R¹¹, R¹³, R¹⁴, and R¹⁵ may be same or different, and each of the same represents a hydrogen atom or an alkyl group having 1 to 2 carbon atoms, R¹² represents an alkyl group having no alcoholic hydroxyl group and having 1 to 4 carbon atoms, R¹⁶ represents an alkyl group having an alcoholic hydroxyl group and having 1 to 4 carbon atoms, and each of n₂ and n₃ is a positive number representing a molar fraction in the repetitive unit.

Among the examples of the constitutional unit (b), the constitutional unit originating from a macromonomer having an ethylenically unsaturated double bond at one of the terminals of a polymer main chain of the macromonomer, the polymer main chain having a repetitive unit represented by the above-described general formula (2-2) (hereinafter this constitutional unit is also referred to as a “constitutional unit (b-2)”), is a constitutional unit originating from a nonionic macromonomer (hereinafter this macromonomer is also referred to as a “macromonomer (b-2)”).

The repetitive unit represented by the general formula (2-2), which is contained in the macromonomer (b-2), is preferably a random copolymer or a block copolymer of a monomer represented by the general formula (6) or the general formula (7) shown below.

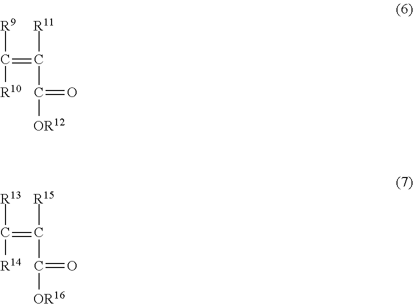

where R⁹, R¹⁰, R¹¹, R¹³, R¹⁴, and R¹⁵ may be same or different and each of the same preferably represents a hydrogen atom or an alkyl group having 1 to 2 carbon atoms, R¹² preferably represents an alkyl group having no alcoholic hydroxyl group and having 1 to 4 carbon atoms, and R¹⁶ preferably represents an alkyl group having an alcoholic hydroxyl group and having 1 to 4 carbon atoms.

In the general formulae (2-2), (6), and (7) shown above, the alkyl group of R¹² and R¹⁶ is preferably a straight-chain or branched-chain alkyl group. Further, in the repetitive unit represented by the general formula (2-2) shown above, the molar fraction n₂ is a positive number, and is preferably 40 to 95%, more preferably 50 to 90%, and further preferably 50 to 80% from the viewpoint of improving the fine dispersion and the dispersion stability of the basic inorganic pigment. The molar fraction n₃ is a positive number, and is preferably 5 to 60%, more preferably 10 to 50%, and further preferably 20 to 50% from the viewpoint of improving the fine dispersion and the dispersion stability of the basic inorganic pigment. Further, from the same viewpoint, the ratio (n₂/n₃) between the molar fraction n₂ and the molar fraction n₃ is preferably 0.7 to 19, more preferably 1 to 9, and further preferably 1 to 4.

Specific examples of the monomer represented by the general formula (6) include methyl (meth)acrylate, ethyl (meth)acrylate, propyl (meth)acrylate, isopropyl (meth)acrylate, n-butyl (meth)acrylate, and isobutyl (meth)acrylate.

Specific examples of the monomer represented by the general formula (7) include 2-hydroxyethyl (meth)acrylate, 2-hydroxypropyl (meth)acrylate, 3-hydroxypropyl (meth)acrylate, 4-hydroxybutyl (meth)acrylate, and glycerol mono(meth)acrylate.

The macromonomer (b-2) is preferably a macromonomer having, at one of the terminals thereof, a (meth)acryloyl group, an allyl group, or a styryl group. An example of a method for producing the macromonomer (b-2) is as follows: alkyl (meth)acrylate is subjected to radical copolymerization in the presence of a carboxylic acid having a mercapto group, whereby a polymer having a carboxyl group at one of the terminals thereof and thereafter, the polymer is subjected to addition reaction with an unsaturated monomer having an epoxy group, such as glycidyl (meth)acrylate. Another example of the producing method is as follows: alkyl (meth)acrylate is subjected to radical copolymerization in the presence of a mercapto compound having a hydroxy group, whereby a polymer having a hydroxy group at one of the terminals thereof is obtained, and thereafter the polymer is subjected to esterification reaction with an unsaturated monomer having a carboxylic acid such as a (meth)acrylic acid.

The macromonomer (b-2) preferably has a weight-average molecular weight of 300 to 30,000, and more preferably, 500 to 15,000, from the viewpoint of improving the fine dispersion and the dispersion stability of the basic inorganic pigment.

The percentage of the constitutional unit (b) in the total amount of the constitutional units composing the high-molecular dispersant of the present invention is 50 to 90 wt %, preferably 55 to 85 wt %, and more preferably 55 to 80 wt % from the viewpoint of improving the fine dispersion and the dispersion stability of the basic inorganic pigment. The constitutional unit (b) in the high-molecular dispersant of the present invention may be formed of both of the constitutional units (b-1) and (b-2), but preferably it is composed of either one of the constitutional units (b-1) and (b-2) from the viewpoint of improving the fine dispersion and the dispersion stability of the basic inorganic pigment.

[Constitutional Unit (c)]

The constitutional unit (c) in the high-molecular dispersant of the present invention is a constitutional unit represented by the general formula (3) shown below. The constitutional unit (c) is hydrophobic, and is considered to suppress re-elution of the basic inorganic pigment into a non-aqueous solvent.

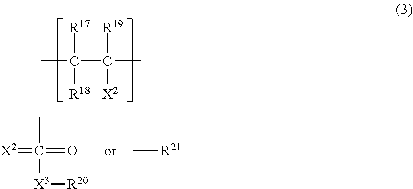

where R¹⁷, R¹⁸, and R¹⁹ may be same or different, and each of the same represents a hydrogen atom or an alkyl group having 1 to 2 carbon atoms, X³ represents an oxygen atom or NH, and each of R²⁰ and R²¹ represents an alkyl group, alkenyl group, or aryl group having 1 to 30 carbon atoms.

The constitutional unit (c) is, for example, a constitutional unit originating from a hydrophobic monomer represented by the general formula (8) shown below.

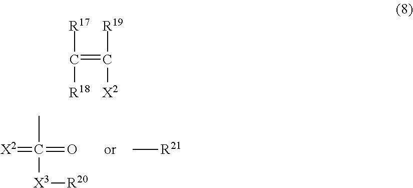

where R¹⁷, R¹⁸, and R¹⁹ may be same or different and each of the same preferably represents a hydrogen atom or an alkyl group having 1 to 2 carbon atoms, X³ preferably represents an oxygen atom or NH, and each of R²⁰ and R²¹ preferably represents either a straight-chain, branched-chain, or cyclic alkyl group, alkenyl group, or aryl group having 1 to 30 carbon atoms.

In the hydrophobic monomer (c) of the general formula (8), each of R¹⁷ and R¹⁸ preferably represents a hydrogen atom, and R²⁰ preferably represents an alkyl group or an alkenyl group having 1 to 22 carbon atoms, from the viewpoint of improving the fine dispersion of the basic inorganic pigment and facilitating the introduction of the constitutional unit (c) into the high-molecular dispersant. Specific examples of R²⁰ include methyl group, ethyl group, butyl group, octyl group, 2-ethylhexyl group, decyl group, lauryl group, myristyl group, cetyl group, stearyl group, oleyl group, and behenyl group. From the same viewpoint, X³ preferably represents an oxygen atom, and R²¹ preferably represents an alkyl group having 1 to 22 carbon atoms or a phenyl group.

Specific examples of the hydrophobic monomer (c) represented by the general formula (8) shown above include ester compounds such as methyl (meth)acrylate, ethyl (meth)acrylate, butyl (meth)acrylate, octyl (meth)acrylate, lauryl (meth)acrylate, stearyl (meth)acrylate, and behenyl (meth)acrylate; amide compounds such as butyl (meth)acrylamide, octyl (meth)acrylamide, lauryl (meth)acrylamide, stearyl (meth)acrylamide, and behenyl (meth)acrylamide; α-olefin such as 1-decen, and 1-octadecen; and styrene. Among these, methyl (meth)acrylate, stearyl (meth)acrylate, and styrene are preferred from the viewpoint of the dispersion stability.

Regarding the content of the constitutional unit (c) in the total amount of the constitutional units, the ratio by weight of the constitutional unit (c) with respect to the nonionic constitutional unit (b) (constitutional unit (c)/constitutional unit (b)) is 0.05 to 0.7, preferably 0.1 to 0.6, and more preferably 0.1 to 0.5, from the viewpoint of improving the fine dispersion of the basic inorganic pigment.

Further, from the viewpoint of suppressing the re-elution of the basic inorganic pigment into the non-aqueous solvent and improving the fine dispersion, the difference (Δsp) between the solubility parameter of the non-aqueous solvent and the solubility parameter of the hydrophobic monomer (c) is preferably 2.0 (MPa)^{1/2} or more, and more preferably 3.0 (MPa)^{1/2} or more. It should be noted that the “solubility parameter” of a monomer in the present invention refers to a value calculated by the Fedors method [R. F. Fedors, Polym. Eng. Sci., 14, 147 (1974)].

[Preparation of High-Molecular Dispersant for Inorganic Pigments]

The high-molecular dispersant of the present invention can be obtained by a known method of for example, polymerizing monomer components by the solution polymerization method, the monomer components including an acidic monomer (a), a nonionic monomer (b-1) or a macromonomer (b-2), and a hydrophobic monomer (c). In one embodiment of the present invention, the percentage (wt %) of the constitutional unit (a) in the total amount of the constitutional units can be regarded, preferably, as a percentage (wt %) of the acidic monomer (a) and/or a monomer to which a neutralizable acidic group can be added after polymerization in the total amount of all the monomer components used in polymerization. Further, the percentage of the constitutional unit (b) in the total amount of the constitutional units can be regarded, preferably, as a percentage (wt %) of the nonionic monomer (b-1) and/or the monomer to which a nonionic group can be introduced after polymerization, or as a percentage (wt %) of the macromonomer (b-2), in the total amount of all the monomer components used in polymerization. Further, the ratio by weight of the constitutional unit (c) with respect to the constitutional unit (b) (constitutional unit (c)/constitutional unit (b)) can be regarded, preferably, as a ratio by weight of the hydrophobic monomer (c) in the total amount of all the monomers used in polymerization, with respect to the nonionic monomer (b-1) and/or either the monomer to which the nonionic group can be introduced after polymerization or the macromonomer (b-2). Therefore, in another aspect, the present invention is a method for producing the high-molecular dispersant of the present invention, the method including polymerizing monomer components that contain the following at the above-described percentages of the constitutional units (a), (b), and (c), respectively: the acidic monomer (a) and/or the monomer to which a neutralizable acidic group can be added after polymerization; the nonionic monomer (b-1) and/or the monomer to which a nonionic group can be introduced after polymerization, or the macromonomer (b-2); and the hydrophobic monomer (c).

Examples of the solvent used in the solution polymerization include organic solvents such as aromatic hydrocarbons (toluene, xylene, etc.), lower alcohols (ethanol, isopropanol, etc.), ketones (acetone, methyl ethyl ketone, etc.), tetrahydrofuran, and diethylene glycol dimethyl ether. The amount of the solvent (by weight) is preferably 0.5 to 10 times the total amount of the monomers.

As a polymerization initiator, a known radical polymerization initiator can be used. Examples of the same include azo-type polymerization initiators, hydroperoxides, dialkyl peroxides, diacyl peroxides, and ketone peroxides. The amount of the polymerization initiator is preferably 0.01 to 5 mole %, more preferably 0.01 to 3 mole %, and particularly preferably 0.01 to 1 mole % with respect to the total amount of the monomer components. The polymerization reaction is preferably carried out at a temperature in a range of 60 to 180° C. under nitrogen flow, and the reaction time is preferably 0.5 to 20 hours.

Upon the polymerization, a polymerization chain transfer agent may be added additionally. Specific examples of the polymerization chain transfer agent include mercaptans such as octyl mercaptan, n-dodecyl mercaptan, t-dodecyl mercaptan, n-tetradecyl mercaptan, mercaptoethanol, 3-mercapto-1,2-propandiol, and mercaptosuccinic acid; thiuram disulfides; hydrocarbons; unsaturated cyclic hydrocarbon compounds; and unsaturated hetero-cyclic compounds. They can be used alone, or two or more of them can be used in mixture.

In the high-molecular dispersant of the present invention, the arrangement of the constitutional units (a), (b), and (c) may be random, block, or graft. The high-molecular dispersant of the present invention may contain a constitutional unit other than these constitutional units, as long as all the requirements regarding the above-described content ranges are satisfied.

The copolymer of the high-molecular dispersant preferably has a weight-average molecular weight of 15,000 to 200,000, more preferably 15,000 to 100,000, and further more preferably 20,000 to 100,000 from the viewpoint of improving the fine dispersion of the basic inorganic pigment. Further, in the case where the basic inorganic pigment has a small average particle diameter (average particle diameter based on a BET specific surface area to be described later) of less than 100 nm (e.g., 20 to 80 nm or 30 to 70 nm), the high-molecular dispersant preferably has a weight-average molecular weight of not less than 1,000 and less than 15,000, more preferably not less than 2,000 and less than 15,000, and further more preferably 2,000 to 10,000 from the viewpoint of improving the fine dispersion of the basic inorganic pigment. It should be noted that the “weight-average molecular weight” refers to a value determined by GPC (gel permeation chromatography), and details of the determination conditions are as shown in Examples.

The high-molecular dispersant for inorganic pigments thus produced is excellent in finely dispersing a basic inorganic pigment in a non-aqueous solvent. Therefore, the high-molecular dispersant of the present invention is preferably used in the dispersion of an inorganic pigment, more preferably used in the dispersion of an inorganic pigment in a non-aqueous solvent, and further more preferably used in the dispersion of a basic inorganic pigment in a non-aqueous solvent.

[Dispersing Method]

Further, as still another aspect, the present invention is capable of providing a dispersing method including dispersing a basic inorganic pigment in a non-aqueous solvent with use of the high-molecular dispersant of the present invention, wherein a difference (Δsp) between a solubility parameter of the non-aqueous solvent and a solubility parameter of a monomer from which the constitutional unit (c) of the high-molecular dispersant of the present invention originates (hydrophobic monomer (c)) is 2.0 (MPa)^{1/2} or more, and preferably 3.0 (MPa)^{1/2} or more. Alternatively, the present invention is capable of providing a dispersing method including dispersing a basic inorganic pigment in a non-aqueous solvent with use of the high-molecular dispersant of the present invention, the method further including selecting the non-aqueous solvent so that a difference Δsp between a solubility parameter of the non-aqueous solvent and a solubility parameter of a monomer from which the constitutional unit (c) of the high-molecular dispersant of the present invention originates (hydrophobic monomer (c)) is 2.0 (MPa)^{1/2} or more, and preferably 3.0 (MPa)^{1/2} or more. The dispersing step includes mixing, for example, the basic inorganic pigment, the high-molecular dispersant of the present invention, and the non-aqueous solvent, preferably together with zirconia beads. Any one skilled in the art can select an appropriate non-aqueous solvent based on the value of the hydrophobic monomer (c). Further, the amounts of the basic inorganic pigment and the high-molecular dispersant of the present invention to be mixed can be set within the ranges of contents of the respective components in a slurry composition to be described below. The dispersing method of the present invention allows a basic inorganic pigment to be dispersed finely in a non-aqueous solvent, and enables the production of a slurry composition to be described below.

[Slurry Composition]

With use of the high-molecular dispersant of the present invention, a slurry composition in which a basic inorganic pigment is dispersed in a non-aqueous solvent can be obtained. Therefore, the present invention, in still another aspect, is capable of providing a slurry composition containing a non-aqueous solvent, a basic inorganic pigment, and a high-molecular dispersant, wherein the high-molecular dispersant is a high-molecular dispersant of the present invention. The slurry composition of the present invention makes it possible to achieve the fine dispersion of a basic inorganic pigment preferably, as will be described later.

The content of the basic inorganic pigment in the slurry composition is preferably 5 wt % to 60 wt %, more preferably 10 wt % to 50 wt %, and further preferably 15 wt % to 40 wt % from the viewpoint of improving the fine dispersion. Further, the content of the high-molecular dispersant of the present invention with respect to 100 parts by weight of the basic inorganic pigment varies with the particle diameter of the basic inorganic pigment, but for example, when a basic inorganic pigment having a volume-average particle diameter (D50) of 10 to 500 nm is used, the content of the high-molecular dispersant is preferably 0.1 to 10 parts by weight, and more preferably 0.2 to 5 parts by weight with respect to the basic inorganic pigment.

Further, in the slurry composition of the present invention, from the viewpoint of improving the fine dispersion of the basic inorganic pigment in the non-aqueous solvent, a difference (Δsp) between a solubility parameter of the non-aqueous solvent contained therein and a solubility parameter of the monomer from which a constitutional unit (c) of the high-molecular dispersant for inorganic pigments originates (hydrophobic monomer (c)) is preferably 2.0 (MPa)^{1/2} or more, and more preferably 3.0 (MPa)^{1/2} or more.

It should be noted that the fine dispersion of a dispersion liquid and a slurry may be evaluated by, for example, the determination of a slurry viscosity; the determination of a sedimentation time of a dispersed inorganic pigment. However, from the knowledge that a slurry has a lower viscosity and a sedimentation time is longer when a particle diameter distribution of an inorganic pigment in the slurry is approximate to the primary particle diameter of powder of the inorganic pigment, the evaluation is enabled by determining the particle diameter distribution of the inorganic pigment in the slurry in the present invention. More specifically, the evaluation is enabled as described in Examples.

Further, the present invention, as still another aspect thereof, is capable of providing a method for producing a slurry composition, the method including the step of mixing a basic inorganic pigment, a dispersant, and a non-aqueous solvent, preferably together with zirconia beads, so as to disperse the basic inorganic pigment, wherein the dispersant is the high-molecular dispersant of the present invention. The amounts of the basic inorganic pigment and the high-molecular dispersant of the present invention that are mixed together may be set in the above-described respective ranges of the contents of the components in the slurry composition. With this producing method, the slurry composition of the present invention can be produced.

[Non-Aqueous Solvent]

The non-aqueous solvent used in the present invention is not limited particularly as long as it is non-aqueous (it is an organic solvent), but those having a solubility parameter of 20 to 30 (MPa)^{1/2} are preferred, and those having a solubility parameter of 21 to 26 (MPa)^{1/2} are more preferred, from the viewpoint of improving the performance of finely dispersing the basic inorganic pigment and the viewpoint of compatibility with the above-described high-molecular dispersant. Specific examples of the same include organic solvents such as xylene (18.2), ethyl acetate (18.2), toluene (18.3), tetrahydrofuran (18.5), methyl ethyl ketone (19.3), acetone (19.7), butyl cellosolve (20.2), dimethylformamide (24.7), n-propanol (24.9), ethanol (26.2), dim ethyl sulfoxide (26.4), n-butanol (28.7), and methanol (29.7). The figures in the parentheses indicate solubility parameters.

Further, it is possible to combine two or more organic solvents so as to adjust the solubility parameter appropriately. The solubility parameter of such a mixture solvent can be determined by experiments, but more easily the solubility parameter thereof can be also determined by calculation based on respective solubility parameters and volume fractions of the components of the mixture solvent. For example, in the case where toluene and ethanol are mixed at volume fractions of 50:50, the solubility parameter of the mixture solvent is determined as follows:

(18.3)×0.5+(26.2)×0.5=22.3

[Basic Inorganic Pigment]

Generally, surfaces of an inorganic pigment have both of an acid site and a base site. The strengths of an acid and a base in a non-aqueous solvent can be determined by reverse titration, and it can be determined whether an inorganic pigment to be dispersed is acidic or basic. Reverse titration is a method of mixing a basic reagent (or an acidic reagent) whose concentration is known preliminarily with an inorganic pigment at a predetermined ratio, sufficiently neutralizing the mixture, subjecting the same to solid-liquid separation by centrifuge or the like, titrating the obtained supernatant solution, and determining an acidity (or a basicity) according to the decrease in the basic reagent (or the decrease in the acidic reagent). The basicity and acidity are determined as follows in the present invention.

1) Determination of Basicity

2 g of an inorganic pigment is weighed (sample amount), then, it is put into 30 mL of 1/100 N acetic acid-toluene/ethanol (ratio by volume: 48:52) solution, and is dispersed with an ultrasonic cleaner (produced by Branson, model: 1510J-MT) for one hour. After left to stand for 24 hours, a part of the inorganic pigment dispersed solution is subjected to solid-liquid separation with a centrifuge (produced by Hitachi, Ltd., model: CP-56G) at 25,000 rpm for 60 minutes. 10 mL of a liquid portion thus separated is added to 20 mL of a toluene/ethanol solvent (ratio by volume 2:1) to which phenolphthalein indicator is added, and thereafter, neutralized by titration with a 1/100 N potassium hydroxide-ethanol solution. An amount used for this titration is assumed to be X mL, an amount used for neutralization of 10 mL of a 1/100 N acetic acid-toluene/ethanol (ratio by volume 48:52) is assumed to be B mL, and a sample amount is assumed to be S g. Then, the basicity is determined by the following formula:

Basicity (μmol/g)=30×(B−X)/S

2) Determination of Acidity

2 g of an inorganic pigment is weighed (sample amount), then, it is put into 30 mL of 1/100 N n-butylamine-toluene/ethanol (ratio by volume: 48:52) solution, and is dispersed with an ultrasonic cleaner (produced by Branson, model: 1510J-MT) for one hour. After left to stand for 24 hours, a part of the inorganic pigment solution is subjected to solid-liquid separation by a centrifuge (produced by Hitachi, Ltd., model: CP-56G) at 25,000 rpm for 60 minutes. 10 mL of a liquid portion thus separated is added to 20 mL of a toluene/ethanol solvent (ratio by volume: 2:1) to which Bromocresol Green indicator is added, and thereafter, neutralized by titration with a 1/100 N hydrochloric acid-ethanol solution. An amount used for this titration is assumed to be X mL, an amount used for neutralization of 10 mL of a 1/100 N n-butylamine-toluene/ethanol (ratio by volume: 48:52) is assumed to be B mL, and a sample amount is assumed to be S g. Then, the acidity is determined by the following formula:

Acidity (μmol/g)=30×(B−X)/S

In the present invention, the “basic inorganic pigment” refers to an inorganic compound having a basicity value, defined as above, greater than an acidity value defined as above, and more specifically, examples of the same include metal oxides such as titanium oxide, magnesium oxide, barium oxide, and aluminum oxide; metal carbonates such as magnesium carbonate and barium carbonate; and composite oxides such as barium zirconate, calcium zirconate, calcium titanate, barium titanate, and strontium titanate.

The average particle diameter (average particle diameter based on BET specific surface area) of a basic inorganic pigment to which the high-molecular dispersant of the present invention is preferably applicable, and the average particle diameter of a basic inorganic pigment contained in the slurry composition of the present invention (volume mean particle diameter (D50)) are preferably 500 nm or less, more preferably 200 nm or less, and further preferably 100 nm or less. From the viewpoint of maintaining the fine dispersion, the above-described particle diameters are preferably 5 nm or more, more preferably 7 nm or more, and further preferably 8 nm or more. In other words, the above-described average particle diameters of the basic inorganic pigment (average particle diameter based on BET specific surface area and/or the volume mean particle diameter (D50)) are preferably 5 nm or more and 500 nm or less, more preferably 7 nm or more and 200 nm or less, and further preferably 8 nm or more and 100 nm or less. It should be noted that the average particle diameter of the basic inorganic pigment (average diameter based on BET specific surface area) preferably refers to an average particle diameter of the basic inorganic pigment in powder form, and is determined in the following manner.

Average Particle Diameter of Basic Inorganic Pigment (Average Particle Diameter Based on BET Specific Surface Area)

The average particle diameter (average particle diameter based on BET specific surface area) of the basic inorganic pigment can be determined by assuming that the pigment is composed of spheres having a particle diameter R (m) and using a BET specific surface area S (m²/g) determined by the nitrogen adsorption method and a specific gravity ρ (g/cm³) of the inorganic fine particles. In other words, since the BET specific surface area is a surface area per unit weight, when the surface area is assumed to be A (m²) and the weight of the particles is assumed to be W (g), the following relational expression is obtained:

$$\begin{matrix}S ( {m}^{2} \text{/} g ) = A ( {m}^{2} ) / W ( g ) \\ = [ 4 \times π \times {( R / 2 )}^{2} ] / [ 4 / 3 \times π \times {( R / 2 )}^{3} \times p \times {10}^{6} ] \\ = 6 / ( R \times p \times {10}^{6} )\end{matrix}$$

When the unit of the particle diameter is converted, an expression of R(nm)=6000/(S×p) is obtained, and an average particle diameter (average particle diameter based on BET specific surface area) can be determined. For example, if the BET specific surface area of barium titanate (specific gravity: 6.0) is 5.0 (m²/g), its average particle diameter (particle diameter based on BET specific surface area) is determined to be 200 nm.

It should be noted that the high-molecular dispersant of the present invention, as having excellent fine dispersion, suppresses re-aggregation of particles, thereby allowing the particles to be dispersed so that the particles assume a state in which they have an average particle diameter close to that of the basic inorganic pigment. In other words, the high-molecular dispersant has a small ratio between an average particle diameter of a basic inorganic pigment (average particle diameter based on BET specific surface area) and an average particle diameter (volume mean particle diameter (D50)) of the basic inorganic pigment in the slurry composition of the present invention (average particle diameter of the basic inorganic pigment in the slurry composition of the present invention/average particle diameter of the basic inorganic pigment), and the ratio is preferably 1 to 1.9, more preferably 1 to 1.8, further preferably 1 to 1.7, and further more preferably 1 to 1.5.

Further, in the present invention, the degree of occurrence of aggregated particles of the basic inorganic pigment in the slurry composition is determined as a ratio of D90/D50, and a smaller value of this ratio indicates fewer occurrence of aggregated particles. Therefore, the fine dispersion in the present specification can be evaluated using the ratio of D90/D50 as an index. D90/D50 of the basic inorganic pigment in the slurry composition is preferably 1.0 to 3.0, more preferably 1.0 to 2.1, and further preferably 1.0 to 1.9. It should be noted that in the present specification, the “volume-median particle diameter (D50)” means a particle diameter at which a cumulative volume frequency calculated on the basis of a volume fraction of particles from the smaller particle diameter side thereof is 50%. Likewise, the “volume-median particle diameter (D90)” means a particle diameter at which a cumulative volume frequency calculated on the basis of a volume fraction of particles from the smaller particle diameter side thereof is 90%.

### EXAMPLE

Hereinafter the present invention is described by way of examples.

[High-Molecular Dispersant Containing Constitutional Unit (b-1)]

### Example 1-1

### Synthesis of High-Molecular Dispersant A (SMA/PEGMA9/MAA)

A separable flask equipped with a reflux tube, a stirring device, a thermometer, and a nitrogen introducing tube was charged with 2.25 g of stearyl methacrylate (SMA: NK-ester S produced by Shin-Nakamura Chemical Co., Ltd.), 10.5 g of methoxy polyethylene glycol (9) methacrylate (PEGMA 9: NK-ester M-90G produced by Shin-Nakamura Chemical Co., Ltd., the average number of moles of added ethylene oxide: 9), 2.25 g of methacrylic acid (MAA: reagent produced by Wako Pure Chemical Industries, Ltd.), and 6.0 g of toluene (reagent produced by Wako Pure Chemical Industries, Ltd.). Gas inside was replaced with nitrogen, and the contents were heated to 65° C. After the inside of the flask reached 65° C., a mixture of 0.45 g of 2,2′-azobis(2,4-dimethylvaleronitrile) (V-65B: produced by Wako Pure Chemical Industries, Ltd.) and 2.5 g of toluene was added thereto. Thereafter, a mixture of 20.25 g of stearyl methacrylate, 94.5 g of methoxy polyethylene glycol (9) methacrylate, 20.25 g of methacrylic acid, 90 g of toluene, and 4.05 g of V-65B was dropped over 3 hours. The contents were stirred at 65° C. for 3 hours, and then, cooled. Toluene was added for the purpose of adjusting concentration, whereby a toluene solution of a high-molecular dispersant A was obtained. The high-molecular dispersant solution had a nonvolatile content of 39.4 wt %, and the high-molecular dispersant had a weight-average molecular weight of 44200. It should be noted that the nonvolatile content of the high-molecular dispersant solution was determined in the following manner. A glass rod and dried anhydrous sodium sulfate, 10 g of which was weight out, were placed in a petri dish, and 2 g of the polymer solution was put therein. The contents were mixed with use of the glass rod, and were dried for 2 hours in a low pressure dryer (pressure: 8 kPa) at 105° C. The contents thus dried were weighed, and the value determined by the following expression was considered to be the nonvolatile content.

Nonvolatile content={[weight of sample−(weight after drying−(weight of petri dish+weight of glass rod+weight of anhydrous sodium sulfate))]/weight of sample}×100

The weight-average molecular weight of the high-molecular dispersant was determined by GPC (column: α-M+α-M produced by Tosoh Corporation, eluent: 60 mmol/L H₃PO₄, 50 mmol/L LiBr/DMF). Specifically, it was determined as described later (this applies to Examples described below, too).

### Example 1-2

### Synthesis of High-Molecular Dispersant B (SMA/PEGMA23/MAA)

A toluene solution of a high-molecular dispersant B was obtained through the same operation as in Example 1-1 described above except that methoxy polyethylene glycol (9) methacrylate (PEGMA9: NK-ester M-90G produced by Shin-Nakamura Chemical Co., Ltd.) in Example 1-1 was replaced with methoxy polyethylene glycol (23) methacrylate (PEGMA 23: NK-ester TM-230G produced by Shin-Nakamura Chemical Co., Ltd., the average number of moles of added ethylene oxide: 23). The high-molecular dispersant solution had a nonvolatile content of 42.1%, and the high-molecular dispersant had a weight-average molecular weight of 68400.

### Examples 1-3 to 1-11, Comparative Examples 1-1 to 1-3

High-molecular dispersants C to N were synthesized in the same manner as in Example 1-1, with use of raw materials shown in Table 1 below, in amounts shown therein (referred to as Examples 1-3 to 1-11, and Comparative Examples 1-1 to 1-3, respectively). The nonvolatile contents and weight-average molecular weights of the high-molecular dispersants are shown in Table 1 below as well. In Table 1 below, MAA represents methacrylic acid, PEGMA represents methoxy polyethylene glycol methacrylate, SMA represents stearyl methacrylate, MMA represents methyl methacrylate, St represents styrene, DMAEMA represents dimethyl amino ethyl methacrylate, IPA represents isopropanol, AIBN represents 2,2′-azodiisobutylonitrile, and MPD represents 3-mercapto-1,2-propanediol.

### Comparative Example 1-4

A high-molecular dispersant O was synthesized by the following method. First, a separable flask equipped with a reflux tube, a stirring device, a thermometer, and a nitrogen introducing tube was charged with 110 g of methoxy polyethylene monomethallyl ether (average molecular weight: 550), 19.6 g of maleic anhydride, 2.4 g of dodecyl mercaptan, and 80 g of toluene, gas inside was replaced with nitrogen, and the contents were heated to 85° C. Subsequently, 2.0 g of 2,2′-azodiisobutylonitrile (AIBN) dissolved in 15 g of toluene was dropped therein over 3 hours at 85° C. After the dropping, the contents were stirred for 3 hours, and then, cooled. Toluene was added for the purpose of adjusting concentration, whereby a toluene solution of a high-molecular dispersant J was obtained. The high-molecular dispersant solution had a nonvolatile content of 42.5%, and the high-molecular dispersant had a weight-average molecular weight of 11800.

Method for Determining Weight-Average Molecular Weight

Eluent was flown at a rate of 1 ml per minute, and a column was stabilized in a high-temperature vessel at 40° C. 100 μl of a sample solution was poured therein, and measurement was carried out. The molecular weight of the sample was calculated based on preliminarily created calibration curves. To create the calibration curves, the following monodisperse polystyrene was used as the standard sample.

Measurement device: HLC-8120GPC (produced by Tosoh Corporation)
Measurement condition: Sample solution: 0.5 wt % N,N-dimethylformamide (DMF) solution
Eluent: 60 mmol/L H₃PO₄, 50 mmol/L LiBr/DMF
Column: α-M+α-M (produced by Tosoh Corporation)
Detector: refractive index detector
Calibration curves: 5.26×10², 1.02×10⁵, 8.42×10⁶ produced by Tosoh Corporation; 4.0×10³, 3.0×10⁴, 9.0×10⁵ produced by Nishio Industry Co., Ltd. (numerical figures represent molecular weights)

TABLE 1

| | | | A | B | C | D | E | F |
|---|---|---|---|---|---|---|---|---|
| | | | Ex. | Ex. | Ex. | Ex. | Ex. | Ex. |
| | | | 1-1 | 1-2 | 1-3 | 1-4 | 1-5 | 1-6 |
| Constitutional unit | MAA | Initial charge (g) | 2.25 | 2.25 | 4.5 | 2.25 | 2.25 | 2.25 |
| (a) | | Dropped liquid (g) | 20.25 | 20.25 | 40.5 | 20.25 | 20.25 | 20.25 |
| Constitutional unit | PEGMA (4) | Initial charge (g) | | | | | | |
| (b) | | Dropped liquid (g) | | | | | | |
| | PEGMA (9) | Initial charge (g) | 10.5 | | | | | |
| | | Dropped liquid (g) | 94.5 | | | | | |
| | PEGMA (23) | Initial charge (g) | | 10.5 | 8.25 | 10.5 | 10.5 | 8.25 |
| | | Dropped liquid (g) | | 94.5 | 74.25 | 94.5 | 94.5 | 74.25 |
| Constitutional unit | SMA | Initial charge (g) | 2.25 | 2.25 | 2.25 | | | 4.5 |
| (c) | | Dropped liquid (g) | 20.25 | 20.25 | 20.25 | | | 40.5 |
| | MMA | Initial charge (g) | | | | 2.25 | | |
| | | Dropped liquid (g) | | | | 20.25 | | |
| | St | Initial charge (g) | | | | | 2.25 | |
| | | Dropped liquid (g) | | | | | 20.25 | |
| Constitutional unit | DMAEMA | Initial charge (g) | | | | | | |
| (Control) | | Dropped liquid (g) | | | | | | |
| | Maleic | Initial charge (g) | | | | | | |
| | anhydride | | | | | | | |
| | Methoxy- | Initial charge (g) | | | | | | |
| | polyethylene | | | | | | | |
| | monomethallyl | | | | | | | |
| | ether | | | | | | | |
| Solvent | Toluene | Initial charge (g) | 6 | 6 | | | | 6 |
| | | Initiator (g) | 2.5 | 2.5 | | | | 2.5 |
| | | Dropped liquid (g) | 90 | 90 | | | | 90 |
| | | Concentration | 100 | 90 | | | | 90 |
| | | Adjuster (g) | | | | | | |
| | Ethanol | Initial charge (g) | | | 9 | 9 | 9 | |
| | | Initiator (g) | | | 3.75 | 3.75 | 3.75 | |
| | | Dropped liquid (g) | | | 81 | 81 | 81 | |
| | | Concentration | | | 100 | 100 | 100 | |
| | | adjuster (g) | | | | | | |
| | IPA | Initial charge (g) | | | | | | |
| | | Initiator (g) | | | | | | |
| | | Dropped liquid (g) | | | | | | |
| | | Concentration | | | | | | |
| | | adjuster (g) | | | | | | |
| Polymerization | V-65B | Initiator (g) | 0.45 | 0.45 | 0.45 | 0.45 | 0.45 | 0.45 |
| initiator | | Dropped liquid (g) | 4.05 | 4.05 | 4.05 | 4.05 | 4.05 | 4.05 |
| Chain transfer | AIBN | Dropped liquid (g) | | | | | | |
| agent | Dodecyl- | Initial charge (g) | | | | | | |
| | mercaptan | | | | | | | |
| | MPD | Initial charge (g) | | | | | | |
| | | Dropped liquid (g) | | | | | | |

| | | | | | | |
|---|---|---|---|---|---|---|
| Weight-average molecular weight | 44,200 | 68,400 | 57,200 | 44,600 | 43,600 | 60,700 |
| Nonvolatile content % | 39.4 | 42.1 | 43.9 | 34.9 | 44.8 | 42.7 |

| | | | G | H | I | J | K |
|---|---|---|---|---|---|---|---|
| | | | Ex. | Ex. | Ex. | Ex. | Ex. |
| | | | 1-7 | 1-8 | 1-9 | 1-10 | 1-11 |
| Constitutional unit | MAA | Initial charge (g) | 2.25 | 0.75 | 3.65 | 2.55 | 1.13 |
| (a) | | Dropped liquid (g) | 20.25 | 6.75 | 32.81 | 22.95 | 10.13 |
| Constitutional unit | PEGMA (4) | Initial charge (g) | | | | 3.83 | 12.75 |
| (b) | | Dropped liquid (g) | | | | 34.43 | 114.75 |
| | PEGMA (9) | Initial charge (g) | | | 7.71 | 6.08 | |
| | | Dropped liquid (g) | | | 69.39 | 54.68 | |
| | PEGMA (23) | Initial charge (g) | 10.5 | 12 | | | |
| | | Dropped liquid (g) | 94.5 | 108 | | | |
| Constitutional unit | SMA | Initial charge (g) | 2.25 | 2.25 | | | |
| (c) | | Dropped liquid (g) | 20.25 | 20.25 | | | |
| | MMA | Initial charge (g) | | | | 2.55 | 1.13 |
| | | Dropped liquid (g) | | | | 22.95 | 10.13 |
| | St | Initial charge (g) | | | 3.65 | | |
| | | Dropped liquid (g) | | | 32.81 | | |
| Constitutional unit | DMAEMA | Initial charge (g) | | | | | |
| (Control) | | Dropped liquid (g) | | | | | |
| | Maleic | Initial charge (g) | | | | | |
| | anhydride | | | | | | |
| | Methoxy- | Initial charge (g) | | | | | |
| | polyethylene | | | | | | |
| | monomethallyl | | | | | | |
| | ether | | | | | | |
| Solvent | Toluene | Initial charge (g) | 6 | 6 | | | |
| | | Initiator (g) | 2.5 | 2.5 | | | |
| | | Dropped liquid (g) | 90 | 90 | | | |
| | | Concentration Adjuster (g) | 100 | 110 | | | |
| | Ethanol | Initial charge (g) | | | 10 | 10 | 10 |
| | | Initiator (g) | | | 3.75 | 3.75 | 3.75 |
| | | Dropped liquid (g) | | | 90 | 90 | 90 |
| | | Concentration adjuster (g) | | | 110 | 110 | 110 |
| | IPA | Initial charge (g) | | | | | |
| | | Initiator (g) | | | | | |
| | | Dropped liquid (g) | | | | | |
| | | Concentration adjuster (g) | | | | | |
| Polymerization | V-65B | Initiator (g) | 0.45 | 0.45 | 0.45 | 0.45 | 0.45 |
| initiator | | Dropped liquid (g) | 4.05 | 4.05 | 4.05 | 4.05 | 4.05 |
| Chain transfer | AIBN | Dropped liquid (g) | | | | | |
| agent | Dodecyl mercaptan | Initial charge (g) | | | | | |
| | MPD | Initial charge (g) | 0.9 | | | | |
| | | Dropped liquid (g) | 8.1 | | | | |

| | | | | | |
|---|---|---|---|---|---|
| Weight-average molecular weight | 5,000 | 62,000 | 14,000 | 25,000 | 45,000 |
| Nonvolatile content % | 43.0 | 36.2 | 31.4 | 30.0 | 34.6 |

| | | | L | M | N | O |
|---|---|---|---|---|---|---|
| | | | Comp. Ex. 1-1 | Comp. Ex. 1-2 | Comp. Ex. 1-3 | Comp. Ex. 1-4 |
| Constitutional unit | MAA | Initial charge (g) | 0.75 | 2.25 | | |
| (a) | | Dropped liquid (g) | 6.75 | 20.25 | | |
| Constitutional unit | PEGMA (4) | Initial charge (g) | | | | |
| (b) | | Dropped liquid (g) | | | | |
| | PEGMA (9) | Initial charge (g) | 8.25 | | | |
| | | Dropped liquid (g) | 74.25 | | | |
| | PEGMA (23) | Initial charge (g) | | 12.75 | 10.5 | |
| | | Dropped liquid (g) | | 114.75 | 94.5 | |
| Constitutional unit | SMA | Initial charge (g) | 6 | | 2.25 | |
| (c) | | Dropped liquid (g) | 54 | | 20.25 | |
| | MMA | Initial charge (g) | | | | |
| | | Dropped liquid (g) | | | | |
| | St | Initial charge (g) | | | | |
| | | Dropped liquid (g) | | | | |
| Constitutional unit | DMAEMA | Initial charge (g) | | | 2.25 | |
| (Control) | | Dropped liquid (g) | | | 20.25 | |
| | Maleic | Initial charge (g) | | | | 19.6 |
| | anhydride | | | | | |
| | Methoxy- | Initial charge (g) | | | | 110 |
| | polyethylene | | | | | |
| | monomethallyl | | | | | |
| | ether | | | | | |
| Solvent | Toluene | Initial charge (g) | | 9 | 9 | 80 |
| | | Initiator (g) | | 3.75 | 3.75 | 15 |
| | | Dropped liquid (g) | | 81 | 81 | |
| | | Concentration | | 90 | 90 | 80 |
| | | Adjuster (g) | | | | |
| | Ethanol | Initial charge (g) | | | | |
| | | Initiator (g) | | | | |
| | | Dropped liquid (g) | | | | |
| | | Concentration | | | | |
| | | adjuster (g) | | | | |
| | IPA | Initial charge (g) | 9 | | | |
| | | Initiator (g) | 2.5 | | | |
| | | Dropped liquid (g) | 90 | | | |
| | | Concentration | 100 | | | |
| | | adjuster (g) | | | | |
| Polymerization | V-65B | Initiator (g) | 0.45 | 0.45 | 0.45 | |
| initiator | | Dropped liquid (g) | 4.05 | 4.05 | 4.05 | |
| Chain transfer | AIBN | Dropped liquid (g) | | | | 2 |
| agent | Dodecyl mercaptan | Initial charge (g) | | | | 2.4 |
| | MPD | Initial charge (g) | | | | |
| | | Dropped liquid (g) | | | | |

| | | | | |
|---|---|---|---|---|
| Weight-average molecular weight | 55,200 | 74,900 | 35,400 | 11,800 |
| Nonvolatile content % | 42.5 | 42.8 | 45.0 | 42.5 |

### Examples 2-1 to 2-15, Comparative Examples 2-1 to 2-4

### Fine Dispersion Test 1

With use of the synthesized high-molecular dispersants A to O of Examples and Comparative Examples as described above, slurry compositions containing 30% of the following barium titanate powders as the basic inorganic pigment were prepared in the following manner: barium titanate powder A (BET specific surface area: 5 m²/g); barium titanate powder B (BET specific surface area: 10 m²/g); and barium titanate powder C (BET specific surface area: 20 m²/g).

Preparation of Slurry Composition

Barium titanate powder, 36 g, and a high-molecular dispersant, 0.3 g (effective content), were charged in a 250 mL container, together with 150 g of zirconia beads having a diameter of 1 mm, and a mixture solvent of toluene/ethanol (ratio by volume: 48/52) was added thereto so that the concentration of solid content of barium titanate was 30%. The mixture solvent had a solubility parameter value (calculated value, hereinafter referred to as “SP value”) of 22.4. Subsequently, the container was shaken with a paint shaker (produced by Asada Iron Works Co., Ltd.) for one hour, so that the contents were crushed and dispersed, whereby a slurry composition was obtained. The particle diameter of this slurry composition was determined in the following manner, and the fine dispersion performance thereof was evaluated based on D50 (particle diameter corresponding to 50% in volume distribution) and D90 (particle diameter corresponding to 90% in volume distribution). When a slurry composition has a value of D50 close to the average particle diameter of barium titanate and has a small value of the D90/D50 ratio, it means that the slurry composition has a narrow particle diameter distribution, and therefore, excellent fine dispersion.

Determination of Particle Diameter

A particle diameter distribution measuring device, “Zetasizer NanoZS”, produced by Sysmex Corporation, which is based on the theory of photon correlation (dynamic light scattering), was used as a particle diameter measuring device used in the determination of a particle diameter of a basic inorganic pigment in a slurry composition. One drop of a non-aqueous slurry composed of a basic inorganic pigment, a high-molecular dispersant, and a non-aqueous solvent, was dropped into 2 mL of a solvent, so as to be diluted. 1.2 mL of this diluted liquid was sampled onto a glass cell having an optical path length of 10 mm, and was placed in a measuring section. It is necessary to enter an index of refraction of the inorganic pigment particles, and an index of refraction and a viscosity of the dispersion medium (organic solvent), as measurement parameters. For example, when the inorganic pigment was barium titanate, 2.40 as the index of refraction of the particles was used. When toluene was used as the dispersion medium, 1.491 as the index of refraction of the dispersion medium and 0.550 as the viscosity of the sample were used. When a mixture solvent of toluene/ethanol (ratio by volume: 48/52) was used, 1.423 as the index of refraction of the dispersion medium, and 0.752 as the viscosity of the sample were used.

Test Results

Results of slurry compositions of Examples 2-1 to 2-15 in which the high-molecular dispersants A to K were used, respectively, and results of slurry compositions of Comparative examples 2-1 to 2-4 in which the high-molecular dispersants L to O were used, respectively, are shown in Table 2 below. In the slurry compositions of Examples 2-1 to 2-15, the high-molecular dispersants A to K having the (c)/(b) ratio by weight in the range of 0.05 to 0.7 were used, and each of the high-molecular dispersants contains, as the constitutional unit (c), any of the copolymer monomer having the solubility parameter difference (Δsp) of 2.0 or more with respect to the SP value of 22.4 of the toluene/ethanol mixture solvent, stearyl methacrylate (SP value: 17.7), methyl methacrylate (SP value: 18.3), and styrene (SP value: 18.9).

TABLE 2

| | | | | | | | | Inorganic | Results of | | |
|---|---|---|---|---|---|---|---|---|---|---|---|
| | | High- | | | | (c)/(b) | | pigment powder | slurry particle diameter | | |
| | | molecular | Constitutional units wt % | | | ratio by | ΔSP value | (Average | determination | | |
| | | dispersant | (a) | (b) | (c) | weight | (MPa^{1/2}) | particle diameter*) | D50 (nm) | D90 (nm) | D90/D50 |
| Example | 2-1 | A | 15 | 70 | 15 | 0.21 | 4.7 | Barium | 274 | 410 | 1.50 |
| | 2-2 | B | 15 | 70 | 15 | 0.21 | 4.7 | Titanate A | 258 | 389 | 1.50 |
| | 2-3 | C | 30 | 55 | 15 | 0.27 | 4.7 | (200 nm) | 282 | 412 | 1.46 |
| | 2-4 | D | 15 | 70 | 15 | 0.21 | 4.1 | | 275 | 405 | 1.47 |
| | 2-5 | E | 15 | 70 | 15 | 0.21 | 3.5 | | 272 | 407 | 1.50 |
| | 2-6 | F | 15 | 55 | 30 | 0.55 | 4.7 | | 319 | 663 | 2.08 |
| | 2-7 | G | 15 | 70 | 15 | 0.21 | 4.7 | | 253 | 425 | 1.68 |
| | 2-8 | H | 5 | 80 | 15 | 0.19 | 4.7 | | 242 | 390 | 1.61 |
| | 2-9 | I | 24 | 52 | 24 | 0.46 | 3.5 | | 334 | 620 | 1.85 |
| | 2-10 | J | 17 | 66 | 17 | 0.26 | 4.1 | | 236 | 378 | 1.60 |
| | 2-11 | K | 7.5 | 85 | 7.5 | 0.09 | 4.1 | | 263 | 450 | 1.71 |
| | 2-12 | B | 15 | 70 | 15 | 0.21 | 4.7 | Barium | 182 | 280 | 1.54 |
| | 2-13 | E | 15 | 70 | 15 | 0.21 | 3.5 | Titanate B | 184 | 278 | 1.51 |
| | | | | | | | | (100 nm) | | | |
| | 2-14 | B | 15 | 70 | 15 | 0.21 | 4.7 | Barium | 120 | 295 | 2.46 |
| | 2-15 | G | 15 | 70 | 15 | 0.21 | 4.7 | Titanate C | 98 | 190 | 1.94 |
| | | | | | | | | (50 nm) | | | |
| Comp. | 2-1 | L | 5 | 55 | 40 | 0.73 | 4.7 | Barium | 450 | 1320 | 2.93 |
| Example | 2-2 | M | 15 | 85 | 0 | 0.00 | — | Titanate A | 347 | 1020 | 2.94 |
| | 2-3 | N | — | 70 | 15 | 0.21 | 4.7 | (200 nm) | 1168 | 2060 | 1.76 |
| | 2-4 | O | | | | | | | 320 | 1648 | 5.15 |

*Value calculated from BET sperific surface area

As shown in Table 2, all the slurry compositions of Examples 2-1 to 2-13 and 2-15 had values of D50 close to the average particle diameter of barium titanate (average particle diameter based on BET specific surface area), and D90/D50 ratios of 2.1 or less. Besides, the slurry compositions of Examples 2-14 and 2-15 contained barium titanate having an average particle diameter of 50 nm, but the fine dispersion of Example 2-15 using the high-molecular dispersant G having a smaller weight-average molecular weight was superior to the fine dispersion of Example 2-14 using the B having a greater weight-average molecular weight. In contrast, Comparative Examples 2-1 and 2-2, in which the high-molecular dispersants L and M having the (c)/(b) ratios by weight out of the range of 0.05 to 0.7, and Comparative Example 2-4 in which the 0 not containing the constitutional units (a) to (c) exhibited large D90/D50 ratios of 2.9 or more, though exhibiting values of D50 close to the average particle diameter of barium titanate. Further, Comparative Example 2-3, not containing the constitutional unit (a), exhibited a significantly larger value of D50 than the average particle diameter of barium titanate. Therefore, it is concluded that the slurry compositions of Examples 2-1 to 2-15 exhibited superior fine dispersion to the slurry compositions of Comparative Examples 21 to 2-4.

### Example 2-16

### Fine Dispersion Test 2

Barium titanate powder having a particle diameter of 200 nm, 36 g, and the high-molecular dispersant B, 0.3 g (effective content), were charged in a 250 mL container, together with 150 g of zirconia beads having a diameter of 1 mm, and toluene was added thereto so that the concentration of solid content of barium titanate was adjusted to be 30%, whereby a slurry composition was obtained (Example 2-16). The B contains, as the constitutional unit (c), stearyl methacrylate (SP value: 17.7), which is a copolymer monomer having a solubility parameter difference (Asp) of less than 1.0 from the SP value of toluene solvent, 18.3. The particle diameter of this slurry composition of Example 2-16 was measured, and its fine dispersion was evaluated based on D50, D90, and D90/D50 ratio. The results are shown in Table 3 below.

TABLE 3

| | High- | SP value (MPa)^{1/2} | | | Results of slurry particle | | |
|---|---|---|---|---|---|---|---|
| | molecular | Constitutional | Non-aqueous | Δsp value | diameter determination | | |
| | dispersant | unit (c) | solvent | (MPa^{1/2}) | D50 (nm) | D90 (nm) | D90/D50 |
| Ex. 2-2 | B | 17.7 | 22.4 | 4.7 | 258 | 389 | 1.50 |
| Ex. 2-16 | B | 17.7 | 18.3 | 0.6 | 450 | 2430 | 5.40 |

As shown in Table 3 above, as compared with Example 2-2 of the fine dispersion test 1 in which the toluene/ethanol mixture solvent was used, the values of D50, D90, and the D90/D50 ratio of the slurry composition of Example 2-16 in which the toluene solvent was used were greater. Thus, the slurry composition of Example 2-2 was superior in terms of fine dispersion.

[High-Molecular Dispersant Containing Constitutional Unit (b-2)]

### Synthesis of Macromonomer

Next, macromonomers were synthesized and macromonomer solutions were prepared in the manners of Production Examples 1 to 5 described below. The compositions of the obtained macromonomers are shown in Table 4 below.

### Production Example 1

A separable flask equipped with a reflux condenser, a thermometer, a nitrogen gas introducing tube, and a stirring device was charged with 34.8 g of methyl methacrylate (MMA), 45.2 g of 2-hydroxyethyl methacrylate (HEMA), 2.4 g of 3-mercaptopropionic acid (MPA), 16 of propylene glycol monomethyl ether acetate (PGMEA), and 16 g of ethanol. After gas inside was replaced with nitrogen, a mixture liquid of 139.2 g of MMA, 180.8 g of HEMA, 9.6 g of MPA, 64 g of PGMEA, 64 g of ethanol, and 3.2 g of 2,2′-azobis(2,4-dimethyl valeronitrile) (V-65) was dropped over 3 hours while the contents were being stirred at 80° C. Further, after the contents were stirred at 80° C. for 1 hour more, 1.15 g of MPA, 3.2 g of V-65, 60 g of PGMEA, and 60 g of ethanol were added thereto. Still further, the contents were stirred at 80° C. for 2 hours. After the contents were cooled to 40° C. or lower, 6.0 g of tetrabutylammonium bromide (TBAB), 0.62 g of methoxyphenol, and 21.2 g of glycidyl methacrylate (GMA) were added thereto. The nitrogen gas introducing tube was replaced with an air introducing tube, and then, while air bubbling was being carried out, the contents were stirred at 90° C. for 15 hours. PGMEA was added for the purpose of adjusting solid content, and a solution of a poly(MMA/HEMA (50/50)) macromonomer having a methacryloyl group at one of the terminals was obtained. It had a weight-average molecular weight of 9480, determined by GPC (solvent: dimethylformamide), and solid content of 60.2%.

### Production Example 2

A separable flask equipped with a reflux condenser, a thermometer, a nitrogen gas introducing tube, and a stirring device was charged with 51.6 g of MMA, 28.4 g of HEMA, 2.4 g of MPA, 20 g of toluene, and 20 g of ethanol. After gas inside was replaced with nitrogen, a mixture liquid of 206.4 g of MMA, 113.6 g of HEMA, 9.6 g of MPA, 80 g of toluene, 80 g of ethanol, and 3.2 g of V-65 was dropped over 3 hours while the contents were being stirred at 80° C. Further, after the contents were stirred at 80° C. for 1 hour more, 1.15 g of MPA, 3.2 g of V-65, 80 g of toluene, and 80 g of ethanol were added thereto. Still further, the contents were stirred at 80° C. for 2 hours. After the contents were cooled to 40° C. or lower, 6.1 g of TBAB, 0.63 g of methoxyphenol, and 21.6 g of GMA were added thereto. The nitrogen gas introducing tube was replaced with an air introducing tube, and then, while air bubbling was being carried out, the contents were stirred at 90° C. for 15 hours. PGMEA was added for the purpose of adjusting solid content, and a solution of a poly(MMA/HEMA (70/30)) macromonomer having a methacryloyl group at one of the terminals was obtained. It had a weight-average molecular weight of 9770, determined by GPC (solvent: dimethylformamide), and a solid content of 53.6%.

### Production Example 3

A separable flask equipped with a reflux condenser, a thermometer, a nitrogen gas introducing tube, and a stirring device was charged with 51.6 g of MMA, 28.4 g of HEMA, 9.6 g of MPA, 16 g of PGMEA, and 16 g of ethanol. After gas inside was replaced with nitrogen, a mixture liquid of 206.4 g of MMA, 113.6 g of HEMA, 38.4 g of MPA, 64 g of PGMEA, 64 g of ethanol, and 3.2 g of V-65 was dropped over 3 hours while the contents were being stirred at 80° C. Further, after the contents were stirred at 80° C. for 1 hour more, 1.15 g of MPA, 3.2 g of V-65, 80 g of PGMEA, and 80 g of ethanol were added thereto. Still further, the contents were stirred at 80° C. for 2 hours. After the contents were cooled to 40° C. or lower, 22.4 g of TBAB, 2.3 g of methoxyphenol, and 79.1 g of GMA were added thereto. The nitrogen gas introducing tube was replaced with an air introducing tube, and then, while air bubbling was being carried out, the contents were stirred at 90° C. for 15 hours. PGMEA was added for the purpose of adjusting solid content, and a solution of a poly(MMA/HEMA (70/30)) macromonomer having a methacryloyl group at one of the terminals was obtained. It had a weight-average molecular weight of 3170, determined by GPC (solvent: dimethylformamide), and a solid content of 67.2%.

### Production Example 4

A separable flask equipped with a reflux condenser, a thermometer, a nitrogen gas introducing tube, and a stirring device was charged with 80 g of ethyl methacrylate (EMA), 2.8 g of MPA, and 40 g of toluene. After gas inside was replaced with nitrogen, a mixture liquid of 320 g of EMA, 11.2 g of MPA, 160 g of toluene, and 3.2 g of V-65 was dropped over 3 hours while the contents were being stirred at 80° C. Further, after the contents were stirred at 80° C. for 1 hour more, 1.15 g of MPA, 3.2 g of V-65, and 160 g of toluene were added thereto. Still further, the contents were stirred at 80° C. for 2 hours. After the contents were cooled to 40° C. or lower, 6.9 g of TBAB, 0.71 g of methoxyphenol, and 24.4 g of GMA were added thereto. The nitrogen gas introducing tube was replaced with an air introducing tube, and then, while air bubbling was being carried out, the contents were stirred at 90° C. for 15 hours. Ethanol was added for the purpose of adjusting solid content, and a solution of a poly(EMA) macromonomer having a methacryloyl group at one of the terminals was obtained. It had a weight-average molecular weight of 6220, determined by GPC (solvent: dimethylformamide), and a solid content of 55.1%.

### Production Example 5

A separable flask equipped with a reflux condenser, a thermometer, a nitrogen gas introducing tube, and a stirring device was charged with 64 g of lauryl methacrylate (LMA), 16 g of HEMA, 2.4 g of MPA, 20 g of toluene, and 20 g of ethanol. After gas inside was replaced with nitrogen, a mixture liquid of 256 g of LMA, 64 g of HEMA, 9.6 g of MPA, 80 g of toluene, 80 g of ethanol, and 3.2 g of V-65 was dropped over 3 hours while the contents were being stirred at 80° C. Further, after the contents were stirred at 80° C. for 1 hour more, 1.15 g of MPA, 3.2 g of V-65, 80 g of toluene, and 80 g of ethanol were added thereto. Still further, the contents were stirred at 80° C. for 2 hours. After the contents were cooled to 40° C. or lower, 6.1 g of TBAB, 0.63 g of methoxyphenol, and 21.6 g of GMA were added thereto. The nitrogen gas introducing tube was replaced with an air introducing tube, and then, while air bubbling was being carried out, the contents were stirred at 90° C. for 15 hours. PGMEA was added for the purpose of adjusting solid content, and a solution of a poly(LMA/HEMA (70/30)) macromonomer having a methacryloyl group at one of the terminals was obtained. It had a weight-average molecular weight of 9250, determined by GPC (solvent: dimethylformamide), and a solid content of 55.4%.

TABLE 4

| | | Prod. | Prod. | Prod. | Prod. | Prod. |
|---|---|---|---|---|---|---|
| | | Ex. 1 | Ex. 2 | Ex. 3 | Ex. 4 | Ex. 5 |
| Repetitive | Methyl | 50% | 70% | 70% | — | — |
| unit | methacrylate | | | | | |
| (Molar | (MMA) | | | | | |
| fraction) | Ethyl | — | — | — | 100% | — |
| | methacrylate | | | | | |
| | (EMA) | | | | | |
| | Lauryl | — | — | — | — | 70% |
| | methacrylate | | | | | |
| | (LMA) | | | | | |
| | 2- | 50% | 30% | 30% | — | 30% |
| | hydroxyethyl | | | | | |
| | methacrylate | | | | | |
| | (HEMA) | | | | | |

| | | | | | |
|---|---|---|---|---|---|
| Weight-average | 9,480 | 9,770 | 3,170 | 6,220 | 9,250 |
| molecular weight | | | | | |
| of macromonomer | | | | | |
| Solid content % | 60.2 | 53.6 | 67.2 | 55.1 | 55.4 |
| of macromonomer | | | | | |

Synthesis of High-Molecular Dispersant

Next, copolymers were synthesized with use of acidic monomers, hydrophobic monomers, and the macromonomers of Production Examples 1 to 5 as described above, and high-molecular dispersants were prepared (Examples 3-1 to 3-11, Comparative Examples 3-1 to 3-4).

### Example 3-1

### Synthesis of Copolymer (MAA/Macromonomer of Prod. Ex. 1/SMA)

A separable flask equipped with a reflux tube, a stirring device, a thermometer, and a nitrogen introducing tube was charged with 3.0 g of stearyl methacrylate (SMA: NK-ester S produced by Shin-Nakamura Chemical Co., Ltd.; hydrophobic monomer (c)), 23.28 g of the macromonomer solution of Production Example 1 (macromonomer (b)), 3.0 g of methacrylic acid (MAA: reagent produced by Wako Pure Chemical Industries, Ltd.; macromonomer (a)), and 8.36 g of ethanol (reagent produced by Wako Pure Chemical Industries, Ltd.). Gas inside was replaced with nitrogen, and the contents were heated to 65° C. After the inside of the flask reached 65° C., a mixture of 0.6 g of 2,2′-azobis(2,4-dimethylvaleronitrile) (V-65: produced by Wako Pure Chemical Industries, Ltd.) and 5.0 g of ethanol was added thereto. Thereafter, 27.0 of SMA, 209.48 g of the macromonomer solution of Production Example 1, 27.0 g of MAA, 75.26 g of ethanol, and 5.4 g of V-65 was dropped over 3 hours. The contents were stirred at 65° C. for 3 hours, and then, cooled. Ethanol was added for the purpose of adjusting concentration, whereby a high-molecular dispersant solution was obtained. The high-molecular dispersant solution had a nonvolatile content of 40.3 wt %, and the high-molecular dispersant (copolymer) had a weight-average molecular weight of 67000.

### Examples 3-2 to 3-10, Comparative Examples 3-1 to 3-4

Copolymers of Examples 3-2 to 3-10 and Comparative Examples of 3-1 to 3-4 were synthesized in the same manner as in Example 3-1, with use of raw materials shown in Table 5 below, in amounts shown therein, and high-molecular dispersant solutions were obtained. The nonvolatile contents and weight-average molecular weights of the high-molecular dispersant solutions are shown in Table 5 below as well. In Table 5 below, St represents styrene, MPD represents 3-mercapto-1,2-propanediol, and MMA represents methyl methacrylate (all of which are reagents produced by Wako Pure Chemical Industries, Ltd.).

It should be noted that nonvolatile content of the high-molecular dispersant solution was determined in the following manner. A glass rod and dried anhydrous sodium sulfate, 10 g of which was weight out, were placed in a petri dish, and 2 g of the polymer solution was put therein. The contents were mixed with use of the glass rod, and were dried for 2 hours in a low pressure dryer (pressure: 8 kPa) at 105° C. The contents thus dried were weighed, and the value determined by the following expression was considered to be the nonvolatile content.

Nonvolatile content={[weight of sample−(weight after drying−(weight of petri dish+weight of glass rod+weight of anhydrous sodium sulfate))]/weight of sample}×100

Further, the weight-average molecular weight of the high-molecular dispersant (copolymer) was determined by GPC (column: α-M+α-M produced by Tosoh Corporation, eluent 60 mmol/L H₃PO₄, 50 mmol/L LiBr/DMF). Detailed determination conditions are shown below (this applies to Production Example 7-20 described later, too).

Method for Determining Weight-Average Molecular Weight

Eluent was flown at a rate of 1 ml per minute, and a column was stabilized in a thermostat at 40° C. 100 μl of a sample solution was poured therein, and measurement was carried out. The molecular weight of the sample was calculated based on preliminarily created calibration curves. To create the calibration curves, the following monodisperse polystyrene was used as the standard sample.

Measurement device: HLC-8120GPC (produced by Tosoh Corporation)
Measurement condition: Sample solution: 0.5 wt % N,N-dimethylformamide (DMF) solution
Eluent 60 mmol/L H₃PO₄, 50 mmol/L LiBr/DMF
Column: α-M+α-M (produced by Tosoh Corporation)
Detector: refractive index detector
Calibration curves: 5.26×10², 1.02×10⁵, 8.42×10⁶ produced by Tosoh Corporation; 4.0×10³, 3.0×10⁴, 9.0×10⁵ produced by Nishio Industry Co., Ltd. (numerical figures represent molecular weights)

TABLE 5

| | | | High-molecular dispersant (Copolymer) | | | | | | | |
|---|---|---|---|---|---|---|---|---|---|---|
| | | | Ex. | Ex. | Ex. | Ex. | Ex. | Ex. | Ex. | Ex. |
| | | | 3-1 | 3-2 | 3-3 | 3-4 | 3-5 | 3-6 | 3-7 | 3-8 |
| Acidic monomer | MAA | Initial charge (g) | 3.0 | 3.0 | 3.0 | 3.0 | 3.0 | 3.0 | 3.0 | 3.0 |
| (a) | | Dropped liquid (g) | 27.0 | 27.0 | 27.0 | 27.0 | 27.0 | 27.0 | 27.0 | 27.0 |
| Macro-monomer | Prod. Ex. 1 | Initial charge (g) | 23.28 | | | | | 23.28 | 23.28 | 23.28 |
| (b) | | Dropped liquid (g) | 209.48 | | | | | 209.48 | 209.48 | 209.48 |
| | Prod. Ex. 2 | Initial charge (g) | | 26.14 | | | 29.8 | | | |
| | | Dropped liquid (g) | | 235.29 | | | 268.91 | | | |
| | Prod. Ex. 3 | Initial charge (g) | | | 20.83 | 20.83 | | | | |
| | | Dropped liquid (g) | | | 187.47 | 187.47 | | | | |
| | Prod. Ex. 4 | Initial charge (g) | | | | | | | | |
| | | Dropped liquid (g) | | | | | | | | |
| | Prod. Ex. 5 | Initial charge (g) | | | | | | | | |
| | | Dropped liquid (g) | | | | | | | | |
| Hydrophobic | SMA | Initial charge (g) | 3.0 | 3.0 | | 3.0 | 1.0 | 3.0 | 3.0 | 3.0 |
| monomer | | Dropped liquid (g) | 27.0 | 27.0 | | 27.0 | 9.0 | 27.0 | 27.0 | 27.0 |
| (c) | MMA | Initial charge (g) | | | | | | | | |
| | | Dropped liquid (g) | | | | | | | | |
| | St | Initial charge (g) | | | 3.0 | | | | | |
| | | Dropped liquid (g) | | | 27.0 | | | | | |
| Solvent | Ethanol | Initial charge (g) | 8.36 | 6.93 | 9.58 | 9.58 | 5.06 | 8.36 | 10.72 | 8.36 |
| | | Initiator (g) | 5.0 | 5.0 | 5.0 | 5.0 | 5.0 | 5.0 | 5.0 | 5.0 |
| | | Dropped liquid (g) | 75.26 | 62.35 | 86.26 | 86.26 | 45.55 | 75.26 | 96.52 | 75.26 |
| Polymerization | V-65 | Initial charge (g) | 0.6 | 0.6 | 0.6 | 0.6 | 0.6 | 0.6 | 0.6 | 0.6 |
| Initiator | | Dropped liquid (g) | 5.4 | 5.4 | 5.4 | 5.4 | 5.4 | 5.4 | 5.4 | 5.4 |
| Chain transfer | MPD | Initial charge (g) | | | | 1.2 | | 0.6 | 0.8 | 1.2 |
| agent | | Dropped liquid (g) | | | | 10.8 | | 5.4 | 7.2 | 10.8 |

| | | | | | | | | |
|---|---|---|---|---|---|---|---|---|
| Weight-average molecular weight | 67,000 | 83,000 | 78,000 | 5,400 | 96,000 | 29,000 | 12,000 | 9,500 |
| Nonvolatile content wt % | 40.3 | 40.2 | 42.6 | 44.6 | 39.8 | 43.5 | 40.6 | 42.2 |

| | | | High-molecular dispersant (Copolymer) | | | | | |
|---|---|---|---|---|---|---|---|---|
| | | | | | Comp. | Comp. | Comp. | Comp. |
| | | | Ex. | Ex. | Ex. | Ex. | Ex. | Ex. |
| | | | 3-9 | 3-10 | 3-1 | 3-2 | 3-3 | 3-4 |
| Acidic monomer | MAA | Initial charge (g) | 3.0 | 3.0 | | 3.0 | 3.0 | 3.0 |
| (a) | | Dropped liquid (g) | 27.0 | 27.0 | | 27.0 | 27.0 | 27.0 |
| Macro-monomer | Prod. Ex. 1 | Initial charge (g) | | 23.28 | 28.26 | 28.26 | | |
| (b) | | Dropped liquid (g) | | 209.48 | 254.36 | 254.36 | | |
| | Prod. Ex. 2 | Initial charge (g) | 26.14 | | | | | |
| | | Dropped liquid (g) | 235.29 | | | | | |
| | Prod. Ex. 3 | Initial charge (g) | | | | | | |
| | | Dropped liquid (g) | | | | | | |
| | Prod. Ex. 4 | Initial charge (g) | | | | | | 25.42 |
| | | Dropped liquid (g) | | | | | | 228.76 |
| | Prod. Ex. 5 | Initial charge (g) | | | | | 25.27 | |
| | | Dropped liquid (g) | | | | | 227.44 | |
| Hydrophobic | SMA | Initial charge (g) | 3.0 | | 3.0 | | 3.0 | 3.0 |
| monomer | | Dropped liquid (g) | 27.0 | | 27.0 | | 27.0 | 27.0 |
| (c) | MMA | Initial charge (g) | | 3.0 | | | | |
| | | Dropped liquid (g) | | 27.0 | | | | |
| | St | Initial charge (g) | | | | | | |
| | | Dropped liquid (g) | | | | | | |
| Solvent | Ethanol | Initial charge (g) | 6.93 | 10.72 | 5.87 | 5.87 | 7.36 | 7.29 |
| | | Initiator (g) | 5.0 | 5.0 | 5.0 | 5.0 | 5.0 | 5.0 |
| | | Dropped liquid (g) | 62.35 | 96.52 | 52.82 | 52.82 | 66.28 | 65.62 |
| Polymerization | V-65 | Initial charge (g) | 0.6 | 0.6 | 0.6 | 0.6 | 0.6 | 0.6 |
| Initiator | | Dropped liquid (g) | 5.4 | 5.4 | 5.4 | 5.4 | 5.4 | 5.4 |
| Chain transfer | MPD | Initial charge (g) | 1.2 | 0.8 | | | | |
| agent | | Dropped liquid (g) | 10.8 | 7.2 | | | | |

| | | | | | | |
|---|---|---|---|---|---|---|
| Weight-average molecular weight | 9,200 | 14,000 | 69,000 | 64,000 | 73,000 | 102,000 |
| Nonvolatile content wt % | 43.4 | 41.6 | 43.2 | 41.5 | 40.9 | 44.2 |

[Preparation of Slurry Composition]

Slurry compositions each of which contained 30% of barium titanate powder (BET specific surface area: 20 m²/g, average particle diameter based on BET specific surface area: 50 nm) as a basic inorganic pigment were prepared with use of the high-molecular dispersants (copolymers) prepared as Examples 3-1 to 3-10 and Comparative Examples 3-1 to 3-4 described above (hereinafter referred to as Examples 3.11 to 3-20 and Comparative Examples 3-5 to 3-8, respectively).

### Example 3-11

Barium titanate powder, 36 g, and the high-molecular dispersant of Example 3-1, 1.44 g (solid content (nonvolatile content): 40.3 wt %), were charged in a 250 mL container, together with 150 g of zirconia beads having a diameter of 1 mm, and a mixture solvent of toluene/ethanol (ratio by volume: 48/52) was added thereto so that the concentration of solid content of barium titanate was adjusted to be 30%. Subsequently, the container was shaken with a paint shaker (produced by Asada Iron Works Co., Ltd.) for one hour, so that the contents were crushed and dispersed, whereby a slurry composition was obtained.

### Examples 3-12 to 3-20, Comparative Examples 3-5 to 3-8

Slurry compositions in which Examples 3-12 to 3-20 and Comparative Examples 3-5 to 3-8 were used, respectively, were obtained in the same manner as the method for preparing the slurry composition of Example 3-11.

Each of the obtained slurry compositions was subjected to particle diameter determination under the conditions described below, and the fine dispersion thereof was evaluated with use of the obtained values of D50 and D90. The particle diameter measurement results of these slurry compositions are shown in Table 6 below.

Determination of Particle Diameter

A particle diameter distribution measuring device, “Zetasizer NanoZS”, produced by Sysmex Corporation, which is based on the theory of photon correlation (dynamic light scattering), was used as a particle diameter measuring device used in the determination of a particle diameter of a basic inorganic pigment in a shiny composition. One drop of a non-aqueous slurry composed of a basic inorganic pigment, a high-molecular dispersant, and a non-aqueous solvent, was dropped into 2 mL of a solvent, so as to be diluted. 1.2 mL of this diluted liquid was sampled onto a glass cell having an optical path length of 10 mm, and was placed in a measuring section. It is necessary to enter an index of refraction of the inorganic pigment particles, and an index of refraction and a viscosity of the dispersion medium (organic solvent), as measurement parameters. For example, when the inorganic pigment was barium titanate, 2.40 as the index of refraction of the particles was used. When toluene was used as the dispersion medium, 1.491 as the index of refraction of the dispersion medium and 0.550 as the viscosity of the sample were used. When a mixture solvent of toluene/ethanol (ratio by volume: 48/52) was used, 1.423 as the index of refraction of the dispersion medium, and 0.752 as the viscosity of the sample were used.

It should be noted that as to the slurry compositions of Examples 3-1 to 3-10, Comparative Examples 3-1, 3-3, and 3-4, their solubility parameters of hydrophobic monomers (c) from which the constitutional units (c) of the high-molecular dispersants (copolymer) originated were as follows: stearyl methacrylate (SP value: 17.7); methyl methacrylate (SP value: 18.3); and styrene (SP value: 18.9). Since the toluene/ethanol mixture solvent as a dispersion medium had a solubility parameter (SP value) of 22.4, the slurry composition of Examples and Comparative Examples except for Comparative Example 3-2 exhibited solubility parameter differences (Asp) of 2.0 (MPa)^{1/2} or more.

Evaluation of Fine Dispersion

The particle diameters of the slurry compositions were determined as described above, and the fine dispersion performance of each composition was evaluated based on D50 (particle diameter corresponding to 50% cumulative volume frequency counted from the smaller particle diameter side in the graph of particle diameter cumulative volume frequency) and D90 (particle diameter corresponding to 90% cumulative volume frequency counted from the smaller particle diameter side in the graph of particle diameter-cumulative volume frequency). When a slurry composition has a value of D50 close to the average particle diameter (50 nm) of barium titanate and has a small value of the D90/D50 ratio, it means that the slurry composition has a narrow particle diameter distribution, and therefore, excellent fine dispersion.

TABLE 6

| | High-molecular | | | | | | | | | Results of slurry particle | | |
|---|---|---|---|---|---|---|---|---|---|---|---|---|
| Slurry | dispersant | | Constitutional unit and wt % | | | | | | Δsp value | diameter determination | | |
| composition | Type | Molecular weight | (a) | | (b) | | (c) | | (MPa)^{1/2} | D50 (nm) | D90 (nm) | D90/D50 |
| Ex. 3-11 | Ex. 3-1 | 67000 | MAA | 15 | Prod. Ex. 1 | 70 | SMA | 15 | 4.7 | 105 | 220 | 2.10 |
| Ex. 3-12 | Ex. 3-2 | 83000 | MAA | 15 | Prod. Ex. 2 | 70 | SMA | 15 | 4.7 | 100 | 230 | 2.30 |
| Ex. 3-13 | Ex. 3-3 | 78000 | MAA | 15 | Prod. Ex. 3 | 70 | St | 15 | 3.5 | 110 | 280 | 2.55 |
| Ex. 3-14 | Ex. 3-4 | 5400 | MAA | 15 | Prod. Ex. 3 | 70 | SMA | 15 | 4.7 | 85 | 155 | 1.82 |
| Ex. 3-15 | Ex. 3-5 | 96000 | MAA | 15 | Prod. Ex. 2 | 80 | SMA | 5 | 4.7 | 110 | 235 | 2.14 |
| Ex. 3-16 | Ex. 3-6 | 29000 | MAA | 15 | Prod. Ex. 1 | 70 | SMA | 15 | 4.7 | 100 | 205 | 2.05 |
| Ex. 3-17 | Ex. 3-7 | 12000 | MAA | 15 | Prod. Ex. 1 | 70 | SMA | 15 | 4.7 | 95 | 180 | 1.89 |
| Ex. 3-18 | Ex. 3-8 | 9500 | MAA | 15 | Prod. Ex. 1 | 70 | SMA | 15 | 4.7 | 85 | 150 | 1.76 |
| Ex. 3-19 | Ex. 3-9 | 9200 | MAA | 15 | Prod. Ex. 2 | 70 | SMA | 15 | 4.7 | 90 | 175 | 1.94 |
| Ex. 3-20 | Ex. 3-10 | 14000 | MAA | 15 | Prod. Ex. 1 | 70 | MMA | 15 | 4.1 | 125 | 360 | 2.88 |
| Comp. Ex. | Comp. Ex. | 69000 | — | | Prod. Ex. 1 | 85 | SMA | 15 | 4.7 | 280 | 1050 | 3.75 |
| 3-5 | 3-1 | | | | | | | | | | | |
| Comp. Ex. | Comp. Ex. | 64000 | MAA | 15 | Prod. Ex. 1 | 85 | — | | — | 240 | 960 | 4.00 |
| 3-6 | 3-2 | | | | | | | | | | | |
| Comp. Ex. | Comp. Ex. | 73000 | MAA | 15 | Prod. Ex. 5 | 70 | MMA | 15 | 4.1 | 180 | 650 | 3.61 |
| 3-7 | 3-3 | | | | | | | | | | | |
| Comp. Ex. | Comp. Ex. | 102000 | MAA | 15 | Prod. Ex. 4 | 70 | SMA | 15 | 4.7 | 150 | 480 | 3.20 |
| 3-8 | 3-4 | | | | | | | | | | | |

As shown in Table 6, all of the slurry compositions of Examples 3-11 to 3-20 exhibited smaller values of D50 and D90/D50 than those of the slurry compositions of Comparative Examples 3-5 to 3-8, which means that they had excellent fine dispersion of barium titanate as a basic inorganic pigment. The slurry compositions of Examples 3-11 to 3-19 exhibited particularly excellent fine dispersion.

### INDUSTRIAL APPLICABILITY

As described above, the present invention is useful in, for example, the field where the nano-dispersion of a basic inorganic pigment in a non-aqueous solvent is utilized the manufacturing process.

1. A high-molecular dispersant for inorganic pigments, the high-molecular dispersant comprising a copolymer that contains a constitutional unit (a), a constitutional unit (b), and a constitutional unit (c),
wherein the constitutional unit (a) accounts for 5 to 45 wt % of the total amount of the constitutional units,
the constitutional unit (b) accounts for 50 to 90 wt % of the total amount of the constitutional units, and
a ratio by weight of the constitutional unit (c) with respect to the constitutional unit (b) (constitutional unit (c)/constitutional unit (b)) is 0.05 to 0.7,
wherein the constitutional unit (a) is a constitutional unit represented by a general formula (1),
the constitutional unit (b) is either a constitutional unit represented by a general formula (2-1), or a constitutional unit originating from a macromonomer having an ethylenically unsaturated double bond at one of the terminals of a polymer main chain of the macromonomer, the polymer main chain having a repetitive unit represented by a general formula (2-2), and
the constitutional unit (c) is a constitutional unit represented by a general formula (3), 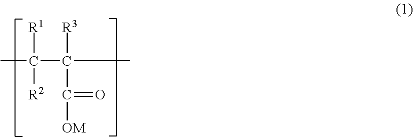
where R¹, R², and R³ are same or different, and each represents a hydrogen atom or an alkyl group having 1 to 2 carbon atoms, and M represents a hydrogen atom or a cation, 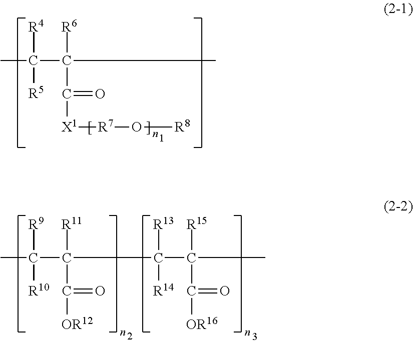
where, in the general formula (2-1), R⁴, R⁵, and R⁶ are same or different, and each represents a hydrogen atom or an alkyl group having 1 to 2 carbon atoms, R⁷ represents a straight-chain or branched-chain alkylene group having 1 to 4 carbon atoms, R⁸ represents a hydrogen atom or an alkyl group having 1 to 2 carbon atoms, X¹ represents an oxygen atom or NH, M represents a hydrogen atom or a cation, and n₁ represents a number in a range of 1 to 50, and
in the general formula (2-2), R⁹, R¹⁰, R¹¹, R¹³, R¹⁴, and R¹⁵ are same or different, and each represents a hydrogen atom or an alkyl group having 1 to 2 carbon atoms, R¹² represents an alkyl group having no alcoholic hydroxyl group and having 1 to 4 carbon atoms, R¹⁶ represents an alkyl group having an alcoholic hydroxyl group and having 1 to 4 carbon atoms, and each of n₂ and n₃ is a positive number representing a molar fraction in the repetitive unit, 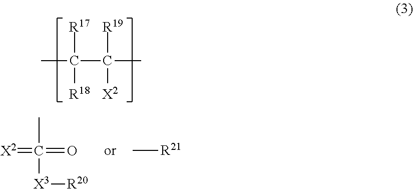
where R¹⁷, R¹⁸, and R¹⁹ are same or different, and each represents a hydrogen atom or an alkyl group having 1 to 2 carbon atoms, X³ represents an oxygen atom or NH, and each of R²⁰ and R²¹ represents an alkyl group, alkenyl group, or aryl group having 1 to 30 carbon atoms.

2. The high-molecular dispersant for inorganic pigments according to claim 1, wherein the copolymer has a weight-average molecular weight of 15,000 to 100,000.

3. The high-molecular dispersant for inorganic pigments according to claim 1, wherein the copolymer has a weight-average molecular weight of not less than 2,000 and less than 15,000.

4. A dispersing method comprising dispersing a basic inorganic pigment in a non-aqueous solvent with use of the high-molecular dispersant for inorganic pigments according to any one of claims 1 to 3,
wherein a difference (Δsp) between a solubility parameter of the non-aqueous solvent and a solubility parameter of a monomer from which a constitutional unit (c) of the high-molecular dispersant for inorganic pigments originates is 2.0 (MPa)^{1/2} or more.

5. A slurry composition comprising a non-aqueous solvent, a basic inorganic pigment, and the high-molecular dispersant for inorganic pigments according to any one of claims 1 to 3.

6. The slurry composition according to claim 5,
wherein the basic inorganic pigment is a metal oxide or a composite oxide selected from the group consisting of magnesium oxide, barium carbonate, titanium oxide, calcium titanate, barium titanate, barium zirconate, and calcium zirconate.
